(19) United States
(12) Patent Application Publication
(10) Pub. No.: US 2025/0216718 A1
(43) Pub. Date: Jul. 3, 2025

(54) DISPLAY DEVICE

(71) Applicant: LG Display Co., Ltd., Seoul (KR)

(72) Inventors: Eun Hee CHOI, Paju-si (KR); Jin Ryun KIM, Paju-si (KR); Ji Gon KIM, Paju-si (KR); Yong Seok LEE, Paju-si (KR); Dae Yong KIM, Paju-si (KR)

(73) Assignee: LG Display Co., Ltd., Seoul (KR)

(21) Appl. No.: 19/004,114

(22) Filed: Dec. 27, 2024

(30) Foreign Application Priority Data
Dec. 29, 2023 (KR) 10-2023-0197874

(51) Int. Cl. G02F 1/13357; G02F 1/1333; G02F 1/1335

(52) U.S. Cl. CPC G02F 1/133605; G02F 1/13338; G02F 1/133524; G02F 1/133603

(57) ABSTRACT

A display device can include a backlight unit, a display panel disposed on the backlight unit and including a first display area and a second display area, and a first sensor and a second sensor disposed under the display panel. The backlight unit includes a light guide plate having a first light guide portion disposed under the first display area and a second light guide portion disposed under the second display area, a light source configured to radiate light to the light guide plate, and a first reflector disposed on the second light guide portion. The first reflector transmits light emitted from the first sensor and reflects light emitted from the second sensor.

### CROSS-REFERENCE TO RELATED APPLICATION

This application claims priority to Korean Patent Application No. 10-2023-0197874, filed in the Republic of Korea on Dec. 29, 2023, the disclosure of which is hereby expressly incorporated by reference in its entirety into the present application.

### BACKGROUND

### 1. Technical Field

Embodiments relate to a display device.

### 2. Discussion of the Related Art

As the information society develops, the demand for display devices to display images is increasing in various forms. In this regard, various display devices such as liquid crystal display devices (LCD), plasma display panels (PDP), and organic light emitting display devices (OLED) have been utilized.

Recently, multimedia functions of electronic devices such as mobile terminals have been improving. For example, cameras are being embedded in mobile terminals as a basic feature, and the resolution of the cameras is increasing to the level of regular digital cameras. However, a front camera of a mobile terminal limits a screen design, which can making the screen design difficult. In order to reduce a space occupied by the camera, screen designs including a notch or a punch hole have been adopted for mobile terminals, but a screen size is still limited due to the camera, making it difficult to implement a full-screen display.

In order to implement the full-screen display, a method of providing an imaging area disposed with low-resolution pixels in a screen of a display panel and disposing a camera and/or various sensors in the imaging area has been proposed.

### SUMMARY OF THE DISCLOSURE

An embodiment of the present disclosure is directed to providing a display device in which an imaging area is not visible from the outside.

In addition, an embodiment of the present disclosure is directed to providing a display device with an improved dark area phenomenon through a first reflector and a second reflector while maintaining the performance of a camera.

In addition, an embodiment of the present disclosure is directed to providing a display device with enhanced transmittance by improving a structure of a display panel and a pixel aperture ratio.

The benefits of embodiments are not limited thereto and can also include benefits or effects that can be identified from the configurations or embodiments to be described below.

A display device according to an embodiment of the present disclosure can include a backlight unit, a display panel disposed on the backlight unit and including a first display area and a second display area, and a first sensor and a second sensor that are disposed under the display panel, wherein the backlight unit can include a light guide plate including a first light guide portion disposed under the first display area and a second light guide portion disposed under the second display area, a light source configured to radiate light to the light guide plate, and a first reflector disposed on the second light guide portion, and the first reflector can transmit light emitted from the first sensor and reflect light emitted from the second sensor.

According to aspects of the present disclosure, the light emitted from the first sensor can be emitted to the outside by passing through the display panel, reflected by an external object, and received by the first sensor.

According to aspects of the present disclosure, the light source is disposed at one side of the light guide plate, and the light guide plate can include a sloped surface disposed at the other side opposite to the one side, and the first reflector can be disposed on the sloped surface.

According to aspects of the present disclosure, the sloped surface may not overlap an upper surface of the light guide plate. A thickness of the light guide plate can decrease toward the other side along the sloped surface.

According to aspects of the present disclosure, the display device can further include a first light-transmitting member disposed between the sloped surface of the light guide plate and the display panel. The first light-transmitting member can be disposed between a second light-emitting unit of the second sensor and the first reflector.

According to aspects of the present disclosure, the first sensor can include a first light-emitting unit and an infrared camera, and the second sensor can include a second light-emitting unit and an RGB camera.

According to aspects of the present disclosure, the display device can further include a first substrate on which the first sensor is disposed, and a second substrate on which the second sensor is disposed. The first substrate and the second substrate can be disposed to intersect each other. The second light-emitting unit can be adjacent to the infrared camera, and the first light-emitting unit can be adjacent to the RGB camera.

According to aspects of the present disclosure, the first sensor and the second sensor can emit light in intersecting directions. The first substrate and the second substrate can be disposed in parallel to each other, and the first substrate and the second substrate can be adjacent to each other in a first direction toward a side portion or a second direction perpendicular to the first direction. The first sensor and the second sensor can overlap at least partially in the first direction.

According to aspects of the present disclosure, the display device can further include a first light-transmitting member disposed between the sloped surface of the light guide plate and the display panel, and a second reflector disposed on the sloped surface of the first light-transmitting member, wherein the second reflector can reflect light emitted from the second sensor to the display panel.

According to aspects of the present disclosure, the display device can further include a second light-transmitting member disposed on the sloped surface of the first light-transmitting member, wherein the second reflector is disposed between the second light-transmitting member and the first light-transmitting member.

According to aspects of the present disclosure, an opening area of a first pixel of the first display area can have an area different from an opening area of a second pixel of the second display area. A second pixel of the second display area can include a 2-1 pixel outputting red, green, and blue light, and a 2-2 pixel outputting white light. An area of the 2-1 pixel can be smaller than an area of the 2-2 pixel.

According to aspects of the present disclosure, the display device can further include an optical sheet disposed on the backlight unit, wherein the optical sheet can include an opening corresponding to the second display area.

According to aspects of the present disclosure, the light source can be disposed on one side of the light guide plate, and the first reflector can be disposed on the other side facing the one side of the light guide plate.

### BRIEF DESCRIPTION OF THE DRAWINGS

The above and other benefits, features and advantages of the present disclosure will become more apparent to those of ordinary skill in the art by describing example embodiments thereof in detail with reference to the accompanying drawings, in which:

FIG. 1 is a perspective view of a display device according to an embodiment of the present disclosure;

FIG. 2A is an exploded perspective view of the display device according to the embodiment of the present disclosure;

FIG. 2B is a schematic view of the display device according to the embodiment of the present disclosure;

FIG. 3 is a cross-sectional view of a display device according to a first embodiment of the present disclosure;

FIG. 4 is a view for describing a cross-section and a function of a first reflector in the display device according to the embodiment of the present disclosure;

FIG. 5 is a flowchart showing a driving method of the display device according to the embodiment of the present disclosure;

FIG. 6 is a first modified example of FIG. 3;

FIG. 7 is a second modified example of FIG. 3;

FIG. 8 is a third modified example of FIG. 3;

FIG. 9 is a cross-sectional view of a display device according to a second embodiment of the present disclosure;

FIG. 10 is a modified example of FIG. 9;

FIG. 11 is a view showing a layer structure between a light guide plate and a first light-transmitting member and various layer structures between the first light-transmitting member and a second light-transmitting member;

FIG. 12 is a modified example of FIG. 9 (lower drawing) and a cross-sectional view along line I-I′ of FIG. 12 (upper drawing);

FIG. 13 is a modified example of FIG. 9 (upper drawing) and a cross-sectional view along line II-II′ of FIG. 13 (lower drawing);

FIG. 14 is a view showing a second display area according to various examples of the display device according to the second embodiment of the present disclosure;

FIG. 15 is a first usage example of a first sensor and a second sensor in the display device according to the embodiment of the present disclosure;

FIG. 16 is an example of a side view of FIG. 15;

FIG. 17 is an example of a plan view of FIG. 15;

FIG. 18 is a view for describing effects of the first usage example of the first sensor and the second sensor in the display device according to the embodiment of the present disclosure;

FIG. 19 is a second usage example of the first sensor and the second sensor in the display device according to the embodiment of the present disclosure;

FIG. 20 is an example of a side view of FIG. 19;

FIG. 21 is an example of a plan view of FIG. 19;

FIG. 22 is a modified example of FIG. 15;

FIG. 23 is an example of a side view of FIG. 22;

FIG. 24 is an example of a plan view of FIG. 22;

FIG. 25 shows various examples of a pixel structure of a display panel in the display device according to the embodiment of the present disclosure;

FIG. 26 shows various examples of the display panel and a polarizing plate in the display device according to various experimental examples;

FIG. 27 is a set of captured images according to various experimental examples of FIG. 26;

FIG. 28 is a view showing various pixel structures with different aperture ratios in a second display area in the display device;

FIG. 29 is a cross-sectional view of the display device having pixels with different aperture ratios according to the embodiment of the present disclosure; and

FIG. 30 is a set of video images according to various pixel structures of FIG. 28.

### DETAILED DESCRIPTION OF THE EMBODIMENTS

Hereinafter, various embodiments according to the present disclosure will be described in detail with reference to the accompanying drawings.

However, the technical idea of the present disclosure is not limited to some of the described embodiments, but can be implemented in various different forms, and one or more of the components among the embodiments can be used by being selectively coupled or substituted without departing from the scope of the technical idea of the present disclosure.

In addition, terms (including technical and scientific terms) used in embodiments of the present disclosure can be construed as meaning that can be generally understood by those skilled in the art to which the present disclosure pertains unless explicitly specifically defined and described, and the meanings of the commonly used terms, such as terms defined in a dictionary, can be construed in consideration of contextual meanings of related technologies.

In addition, the terms used in the embodiments of the present disclosure are for describing the embodiments and are not intended to limit the present disclosure. The term “can” fully encompasses all the meanings and coverages of the term “may.”

In the disclosure, a singular form can include a plural form unless otherwise specified in the phrase, and when described as “at least one (or one or more) of A, B, and C,” one or more among all possible combinations of A, B, and C can be included.

In addition, the terms, such as first, second, A, B, (a), and (b) can be used to describe components of the embodiments of the present disclosure.

These terms are only for the purpose of distinguishing one component from another component, and the nature, sequence, order, or the like of the corresponding components is not limited by these terms.

In addition, when a first component is described as being “connected,” “coupled,” or “joined” to a second component, it can include a case in which the first component is directly connected, coupled, or joined to the second component, but also a case in which the first component is “connected,” “coupled,” or “joined” to the second component by other components present between the first component and the second component.

In addition, when a certain component is described as being formed or disposed on “on (above)” or “below (under)” another component, the terms “on (above)” or “below (under)” can include not only a case in which two components are in direct contact with each other, but also a case in which one or more other components are formed or disposed between the two components. In addition, when described as “on (above) or below (under),” it can include the meaning of not only an upward direction but also a downward direction based on one component.

Various embodiments of the present disclosure will now be described referring to the drawings. All the components of each display device according to all embodiments of the present disclosure are operatively coupled and configured.

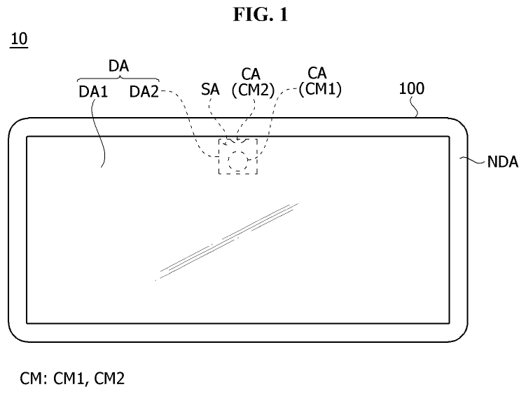

FIG. 1 is a perspective view of a display device according to one or more embodiments of the present disclosure.

Referring to FIG. 1, a display device 10 according to the embodiment can include a display panel 100 for displaying images and a sensor CM for capturing images.

The display device 10 of the embodiments can be applied to various electronic devices such as smartphones, tablets, smart pads, TVs, and monitors. The display panel 100 can include a display area DA including a plurality of sub-pixels and a non-display area NDA located at at least one side of the display area DA. As shown, the non-display area NDA is disposed on a portion of the display panel 100, but is not limited thereto. The non-display area NDA can surround the display area DA entirely or only in part(s).

The display area DA can include a first display area DA1 and a second display area DA2. A plurality of pixels in the first display area DA1 can emit light, and images can be displayed by the emitted light. The second display area DA2 can overlap the sensor CM. The second display area DA2 can include a sensing area CA overlapping the sensor CM and a surrounding area SA adjacent to the sensing area CA.

The sensor CM can be placed under the display panel 100. The sensor CM can be disposed to be spaced apart from the display panel 100. An area of the second display area DA2 is formed to be larger than an area of the sensor CM, but is not limited thereto. For example, the second display area DA2 and the sensor CM can be formed to have substantially the same area, or the second display area DA2 can be formed to be smaller than the sensor CM.

In addition, the sensor CM is formed to overlap an upper area of the display area DA, but is not limited to thereto. The location of the sensor CM can vary under the display panel 100 depending on an electronic device to which the display device 10 is applied. For example, the sensor CM can overlap an upper left area or upper central area of the display area DA. Corresponding to the location of the sensor CM, the second display area DA2 can also be disposed in the upper left area or upper central area.

In addition, the sensor CM can include a first sensor CM1 and a second sensor CM2. The first sensor CM1 can include a first light-emitting unit and a first light-receiving unit. The second sensor CM2 can include a second light-emitting unit and a second light-receiving unit. The first sensor CM1 and the second sensor CM2 can receive light in different wavelength bands. In addition, the first light-emitting unit and the second light-emitting unit can emit light in different wavelength bands. The light-emitting unit can correspond to a “transmitting unit,” and the light-receiving unit can correspond to a “receiving unit.”

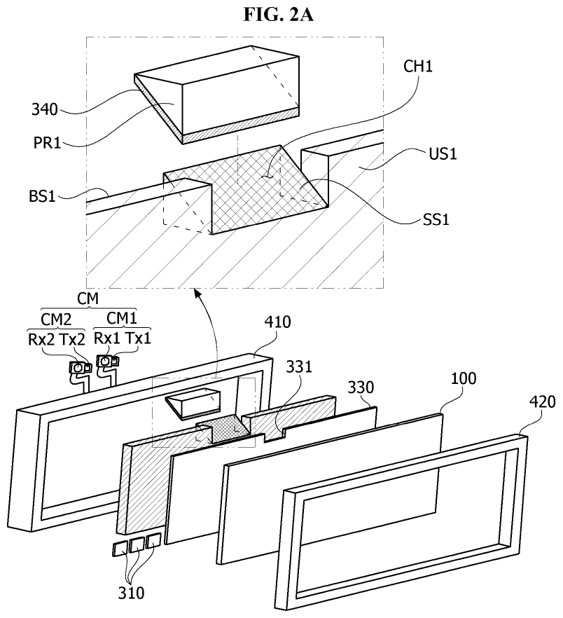

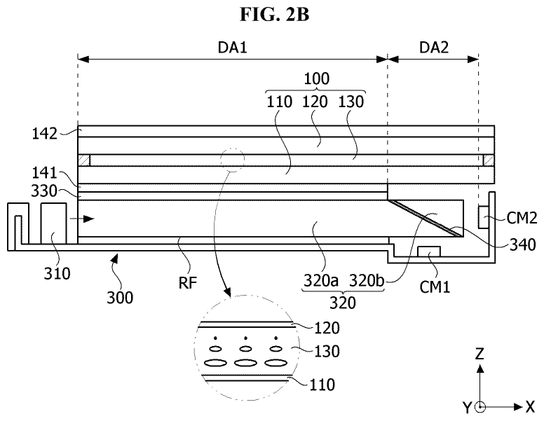

FIG. 2A is an exploded perspective view of the display device according to the embodiment of the present disclosure. FIG. 2B is a schematic cross-sectional view of the display device according to the embodiment of the present disclosure.

Referring to FIGS. 2A and 2B, the display device 10 according to the embodiment can include a display panel 100, a backlight unit 300, and a case member.

The display panel 100 can include a lower substrate 110, an upper substrate 120, and a liquid crystal layer 130 interposed between the lower substrate 110 and the upper substrate 120. The lower substrate 110 and the upper substrate 120 can be formed of glass or plastic.

Signal lines and pixels can be provided on an upper surface of the lower substrate 110 of the display panel 100. The signal lines can include data lines and gate lines that intersect each other, a common line for supplying a common voltage to common electrodes, and gate control signal lines for supplying a control signal to a gate driving circuit. Pixels can be disposed in intersection areas of the data lines and the gate lines. Each of the pixels can include a thin film transistor (TFT), a pixel electrode, and a common electrode. The thin film transistor can supply a data voltage of the data line to the pixel electrode in response to a gate signal of the gate line.

A liquid crystal of the liquid crystal layer 130 can be driven by an electric field generated by a potential difference between the data voltage supplied to the pixel electrode and the common voltage supplied to the common electrode, thereby adjusting the transmission amount of light incident from the backlight unit 300.

A black matrix and a color filter can be provided on a bottom surface of the upper substrate 120 of the display panel 100. The bottom surface of the upper substrate 120 can be a surface facing the lower substrate 110. As described below, the display panel 100 can have a flip-type structure in which the black matrix and the color filter are disposed on the upper substrate 120.

In addition, the common electrode can be provided on the bottom surface of the upper substrate 120 in a vertical electric field driving method such as a twisted nematic (TN) mode and a vertical alignment (VA) mode, and provided on the upper surface of the lower substrate 110 in a horizontal electric field driving method such as an in plane switching (IPS) mode and a fringe field switching (FFS) mode.

Since the black matrix is formed of a light blocking material in a matrix structure, light leakage to an area other than a pixel area can be blocked.

The color filter can be located between the black matrices in the pixel area. The color filter can include a red color filter, a green color filter, and a blue color filter.

An upper polarizing plate 142 can be located on the upper substrate 120 of the display panel 100. In addition, a lower polarizing plate 141 can be located on the lower substrate 110 of the display panel 100. A light transmission axis of the upper polarizing plate 142 can intersect or can be orthogonal to a light transmission axis of the lower polarizing plate. In addition, an alignment layer for setting a pre-tilt angle of the liquid crystal can be disposed on inner surfaces of the upper substrate 120 and the lower substrate 110 that are in contact with the liquid crystal.

The backlight unit 300 can include a light source 310, a light guide plate 320, a reflective sheet RF, an optical sheet 330, a first reflector 340, etc. The backlight unit 300 can convert light emitted from a plurality of light sources 310 into uniform surface light through the light guide plate 320 and the optical sheet 330 and provide the light to the display panel 100. The backlight unit 300 is described as being implemented in an edge type, but is not limited thereto and can also be implemented in a direct type.

The light source 310 can be singular or plural. The light source 310 can be implemented as a light emitting diode (LED). In this case, the light emitting diode can output light in various wavelength bands. For example, the light emitting diode can include at least one of a blue light emitting diode outputting blue light, a red light emitting diode outputting red light, and a magenta light emitting diode outputting magenta light which is a mixture of blue light and red light. The light emitted from the light emitting diode can be converted into white light by a wavelength conversion layer and incident on the light guide plate 320.

The light source 310 can be disposed on at least one side surface of the light guide plate 320 to radiate light on the side surface of the light guide plate 320. The light source 310 can be mounted on a light source circuit board and turned on and off by receiving a driving current from a light source driving circuit.

The light guide plate 320 can convert the light emitted from the light source 310 into surface light and radiate the light to the display panel 100. The reflective sheet RF can be disposed on a bottom surface of the light guide plate 320 to reflect light directed downward from the light guide plate 320.

The light guide plate 320 can include a first light guide portion 320a and a second light guide portion 320b. The first light guide portion 320a can be disposed under the first display area DA1. The first light guide portion 320a can overlap the first display area DA1 in a stacking direction. The stacking direction (a Z-axis direction) can correspond to a direction from the light guide plate 320 toward the display panel 100. In addition, the second light guide portion 320b can be disposed under the second display area DA2. The second light guide portion 320b can overlap the second display area DA2 in the stacking direction.

The optical sheet 330 can be disposed between the light guide plate 320 and the display panel 100. The optical sheet 330 can include at least one prism sheet or at least one diffusion sheet. The optical sheet 330 can diffuse light incident from the light guide plate 320 and refract an optical path so that the light is incident at an angle substantially perpendicular to a light incident surface of the display panel 100.

The first reflector 340 can be disposed obliquely in the second display area DA2. In particular, the first reflector 340 can be disposed obliquely with respect to a direction (an X-axis direction) from the light source 310 toward the light guide plate. In addition, the first reflector 340 can be disposed obliquely with respect to the upper surface and bottom surface of the light guide plate 320. For example, the first reflector 340 can be located on a sloped surface of the light guide plate 320. In addition, the first reflector 340 and the sloped surface of the light guide plate 320 can be located at a predetermined angle other than a right angle with respect to the upper surface and bottom surface of the light guide plate 320.

The first reflector 340 can be disposed between the first light guide portion 320a and the second light guide portion 320b. The light guide plate 320 can include a chamfered portion CH1 overlapping the second display area DA2 so that the first reflector 340 is disposed thereon. For example, the chamfered portion CH1 can be located at an edge of the light guide plate 320 or in a partial area of the light guide plate 320. For example, the first reflector 340 can be located at the edge of the light guide plate 320.

The first reflector 340 can be disposed on the chamfered portion CH1 having a sloped surface SS1. The first reflector 340 can have a sloped surface that is not perpendicular to the direction (the X-axis direction) from the light source 310 toward the light guide plate 320. In addition, a reflecting surface of the first reflector 340 can form a predetermined angle by intersecting the direction from the light source 310 toward the light guide plate 320.

Corresponding to the sloped surface SS1 and the first reflector 340, the optical sheet 330 can include an opening 331 formed in the sensor or the second display area DA2. With this configuration, the luminance of the light incident under the second display area DA2 can be increased. However, the present disclosure is not necessarily limited to thereto, and the opening of the optical sheet 330 can be omitted.

The sensor CM can include a first sensor CM1 and a second sensor CM2. The first sensor CM1 can include a first light-emitting unit Tx1 and a first light-receiving unit Rx1. The second sensor CM2 can include a second light-emitting unit Tx2 and a second light-receiving unit Rx2. In addition, the second sensor CM2 can include only the second light-emitting unit Tx2. As light emitted from the second light-emitting unit Tx2 is provided to the display panel, a dark area of the second display area DA2 can be reduced.

The first sensor CM1 and the second sensor CM2 can be referred to as “a camera module,” “a camera sensor,” “a camera unit,” etc. For example, the first sensor CM1 can be an infrared camera. Alternatively, the first sensor CM1 can be an infrared sensor (IR sensor). The second sensor CM2 can be an RGB sensor or an RGB camera.

The first light-emitting unit of the first sensor CM1 can radiate infrared ray (IR). The first light-receiving unit can receive reflected light of the radiated infrared ray reflected from an object (e.g., a person, etc.). Therefore, the first sensor CM1 can adjust the amount of light depending on an intended use or a distance to a user. The amount of light of the first sensor CM1 can have an optimal amount of light based on the intended use or the distance to the user. The first sensor CM1 according to various embodiments can be operated using a preset optimal amount of light corresponding to the intended use or the distance to the user.

In addition, the first sensor CM1 can extract characteristics of a subject. According to various embodiments, the first sensor CM1 can generate image data, etc. that can recognize that the subject is a user's face when the subject is the user's face by receiving the reflected light. In addition, the first sensor CM1 can generate data distinguishing a direction of a face and a location of the face. For example, the first sensor CM1 can generate or extract data to identify a shape of the face and identify locations of eyes, a nose, a mouth, a forehead, etc. of the face. In addition, the recognition of the subject, the extraction and generation of data, etc. can be performed in a display device or electronic device that are provided with the first sensor CM1 rather than the first sensor CM1. In the above description, the subject was described as the user's face, but is not limited thereto. In addition, the sensor CM can extract not only the characteristics of the subject but also a heart rate, iris information, etc. and extract various pieces of other subject information. In addition, the second sensor CM2 is an RGB camera and can receive RGB image data.

The case member can include a bottom cover 410, a support frame, and a top cover 420.

The bottom cover 410 can have a structure that surrounds the backlight unit 300 or the display panel 100. For example, the bottom cover 410 can be a quadrangular frame. In addition, the bottom cover 410 can be formed of various materials. For example, the bottom cover 410 can be formed of metal. Therefore, reliability of the display device can be improved.

The top cover 420 can surround an edge of the display panel 100, an upper surface and side surfaces of the support frame, and side surfaces of the bottom cover 410. However, sizes of the top cover and the bottom cover can be changed in various ways.

In addition, the top cover 420 can be made of electronic galvanized iron (EGI), stainless steel, or the like. The top cover 420 can be fixed to the support frame with hooks or screws. In addition, a buffer member can be located between the upper substrate and the top cover. As a result, the upper substrate of the display panel 100 can be protected from an impact by the top cover 420.

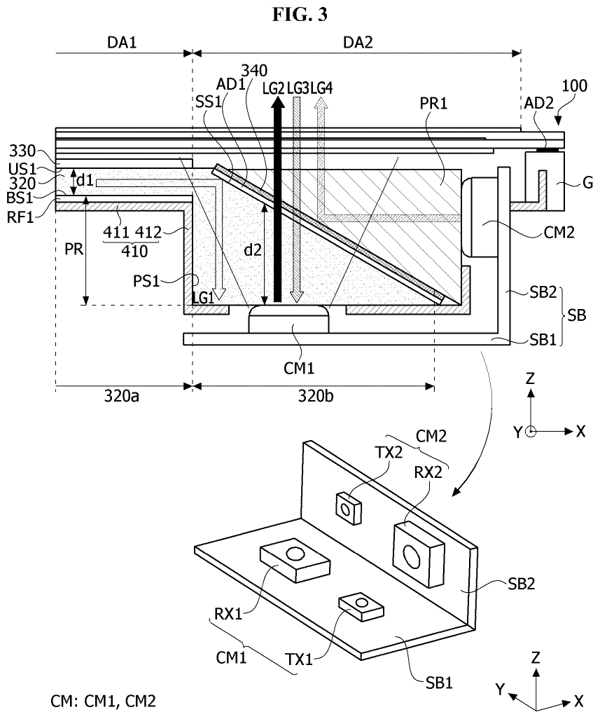

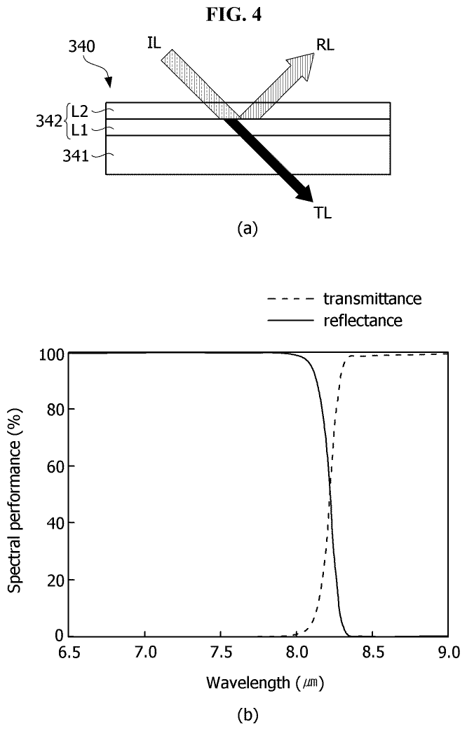

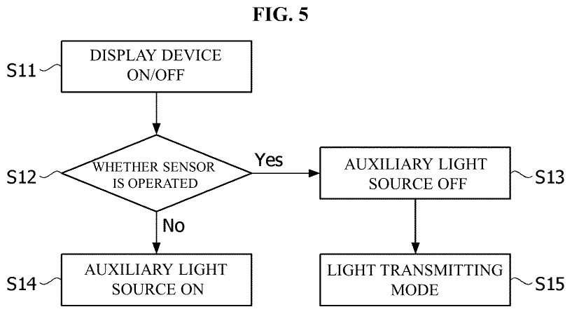

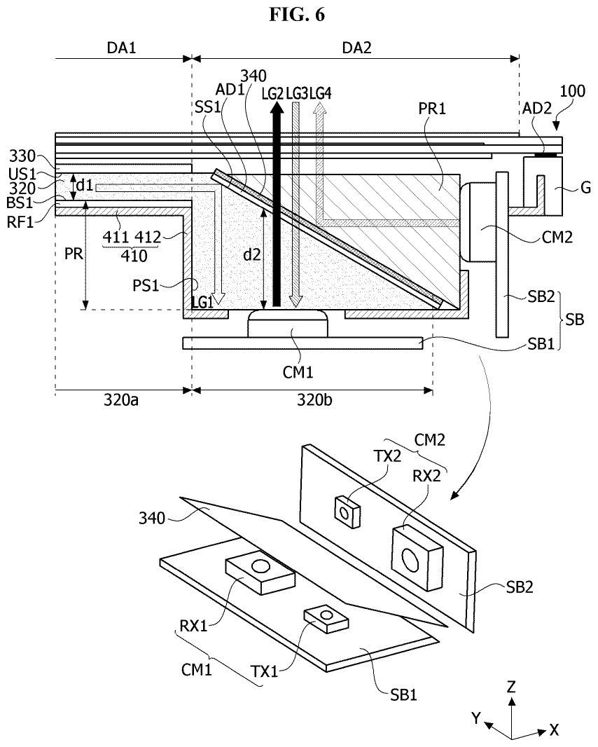

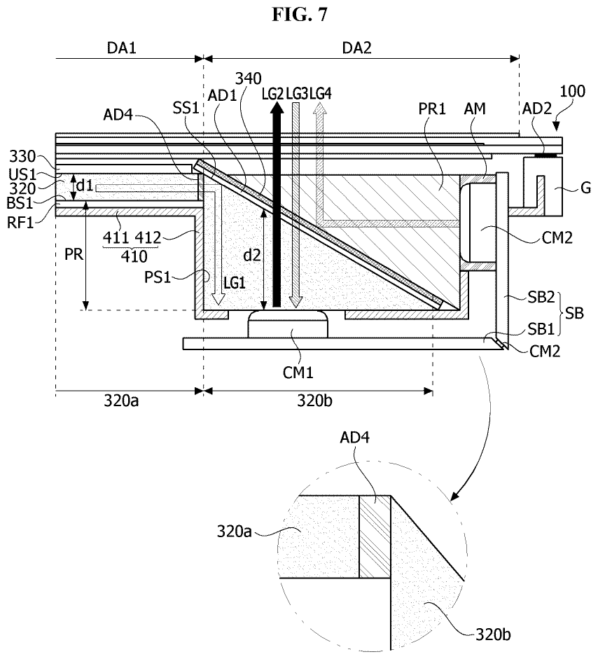

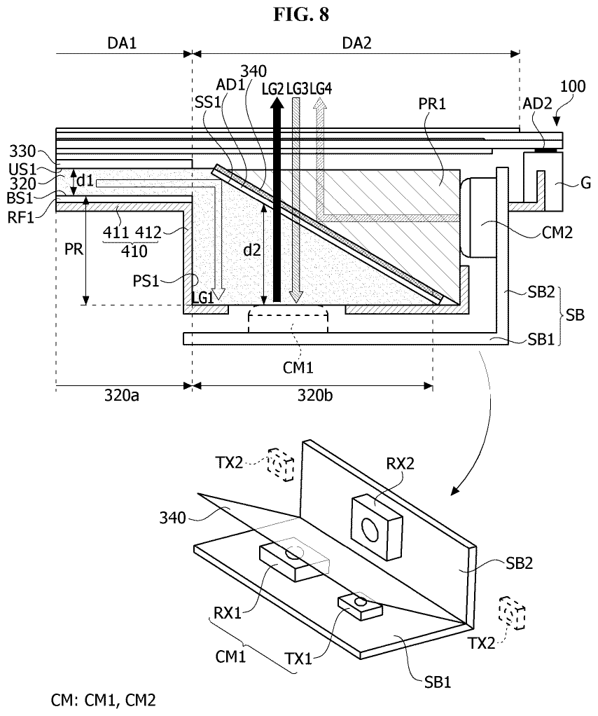

FIG. 3 is a cross-sectional view of a display device according to a first embodiment of the present disclosure. FIG. 4 is a view for describing a cross-section and a function of a first reflector in the display device according to the embodiment of the present disclosure. FIG. 5 is a flowchart showing a driving method of the display device according to the embodiment of the present disclosure. FIG. 6 is a first modified example of FIG. 3. FIG. 7 is a second modified example of FIG. 3. FIG. 8 is a third modified example of FIG. 3.

Referring to FIG. 3, as described above, the light guide plate 320 can include an upper surface US1, a bottom surface BS1, and a sloped surface SS1. For example, the upper surface US1 and the bottom surface BS1 can be flat surfaces and can be surfaces facing each other in the stacking direction.

In the light guide plate 320, the upper surface US1 and the bottom surface BS1 can be spaced apart from each other and can be connected by side surfaces and the sloped surface SS1. The sloped surface SS1 can be located in a partial area of the light guide plate 320. In addition, the sloped surface SS1 can be located inside the light guide plate 320 or at the edge of the light guide plate 320, and can be located between the upper surface US1 and the bottom surface BS1 or outside the upper surface US1 or the bottom surface BS1 of the light guide plate 320.

The sloped surface SS1 can be located on the second light guide portion 320b. In addition, the sloped surface SS1 can be located under the second display area DA2. In addition, the sloped surface SS1 can be a surface sloped at a predetermined angle with respect to the upper surface US1 and the bottom surface BS1. The sloped surface SS1 may not overlap the upper surface US1 of the light guide plate.

The sloped surface SS1 can be located on the light guide plate 320, particularly on a light opposing portion or opposing light incident portion that opposes to a light incident portion facing the light source 310.

Therefore, the first reflector 340 on the sloped surface SS1 can easily reduce the dark area generated by the first sensor CM1 by reflecting visible light emitted to the light opposing portion. In the embodiment, the first reflector 340 can reflect light emitted from the light source 310 and the second sensor CM2.

The first reflector 340 can be in contact with the light guide plate 320 or the second light guide portion 320b. In particular, the first reflector 340 can be disposed above the sloped surface SS1. For example, the first reflector 340 can be in contact with the sloped surface SS1. In addition, a first adhesive member AD1 can be located between the first reflector 340 and the sloped surface SS1. By the first adhesive member AD1, the first reflector 340 can be bonded to the sloped surface SS1. Therefore, the bonding strength between the first reflector 340 and the light guide plate 320 can be increased.

In addition, the sloped surface SS1 can be located between the first reflector 340 and the first sensor CM1. In addition, an air gap can be formed between the second light guide portion 320b and the first sensor CM1.

The first reflector 340 can be referred to as a “filter” or a “first reflecting member.” The first reflector 340 can be configured to reflect light in a visible wavelength band and transmit light in an infrared wavelength band. For example, the first reflector 340 can be a dichroic filter, but is not limited thereto and various types of filters can be applied without any limitation.

In addition, the sloped surface SS1 can have various optical patterns for diffusion. Therefore, light reflected from the first reflector 340 provided on the sloped surface SS1 can be diffused toward the display panel 100. Therefore, the dark area in the second display area can be reduced, and occurrence of a bright line, etc. due to the reflected light can be suppressed. For example, light uniformity can be improved.

Referring further to FIG. 4, the first reflector 340 can include a light transmitting substrate 341 and a plurality of layers 342. For example, the light transmitting substrate 341 can be formed of a light transmitting material such as glass.

In addition, the plurality of layers 342 can be located on the light transmitting substrate 341. For example, the plurality of layers 342 can include a first layer L1 and a second layer L2. The first layer L1 can be located between the second layer L2 and the light transmitting substrate 341. In addition, the first layer L1 and the second layer L2 can be formed of materials with different refractive indices.

For example, the first layer L1 can have a high refractive index characteristic compared to the second layer L2. In addition, the second layer L2 can have a low refractive index characteristic compared to the first layer L1. For example, the first layer L1 can be a high refractive index layer, and the second layer L2 can be a low refractive index layer.

In this case, the first layer L1 and the second layer L2 can have predetermined refractive indices according to desired wavelengths of light for transmittance and reflection. In addition, each of the first layer L1 and the second layer L2 can be formed of multiple layers rather than a single layer, and the multiple first layers L1 and the multiple second layers L2 can be alternately stacked.

The reflected light RL with respect to the incident light IL in the entire wavelength band can be light in the visible wavelength band. In addition, the transmitted light TL can be light in the infrared wavelength band.

Referring back to FIG. 3, the first reflector 340 can reflect light LG1 and LG4 in the visible wavelength band. The first reflector 340 can reflect downward the light LG1 emitted from the first light guide portion 320a and reflect upward the light LG4 emitted from the second sensor CM2.

Specifically, the second light-emitting unit TX2 of the second sensor CM2 can perform the same or substantially same function as the light source. For example, the second light-emitting unit TX2 of the second sensor CM2 can emit light in the visible wavelength band. The first reflector 340 can reflect the light LG4 emitted from the second light-emitting unit upward or to the display panel 100. In addition, visible light reflected from external light or an object can be reflected from the first reflector 340 and provided to the second sensor CM2.

According to the embodiment, since the light LG4 emitted from the second light-emitting unit is emitted to the second display area DA2, the dark area generated in the second display area DA2 can be reduced. In addition, when the amount of light of the second light-emitting unit is controlled by the second sensor CM2, occurrence of a bright line, etc. can be suppressed, or the light uniformity between the first display area DA1 and the second display area DA2 can be improved.

The first reflector 340 can transmit the light emitted from the first sensor CM1. For example, the first reflector 340 can transmit the light LG2 and LG3 in the infrared wavelength band. Therefore, the light L3 which is reflected from an external object or object among the light LG2 emitted from the first light-emitting unit of the first sensor CM1 can be provided to the first light-receiving unit.

In addition, corresponding to the location of the sloped surface SS1, the first reflector 340 can be located to face the light source disposed at one side of the light guide plate 320. For example, the first reflector 340 can be disposed at the other side of the light guide plate 320. In the embodiments of the present disclosure, one side of the light guide plate 320 can correspond to the light incident portion adjacent to the light source, and the other side of the light guide plate 320 can correspond to the light opposing portion or opposing light incident portion that opposes the light incident portion. In other words, the first reflector 340 can be located closer to the light opposing portion or the opposing light incident portion than the light incident portion.

In addition, the upper surface US1 of the light guide plate 320 can be disposed adjacent to the optical sheet 330. For example, the upper surface US1 of the light guide plate 320 can be disposed closer to the optical sheet 330 than the bottom surface BS1 is. In addition, the optical sheet 330 can be located on the upper surface of the light guide plate 320. Moreover, the upper surface US1 of the light guide plate 320 can be located closer to the display panel 100 than the bottom surface BS1 is. In addition, the optical sheet 330 can be located on at least portion of the upper surface US1.

The optical sheet 330 may not be located in an area of the upper surface US1 that overlaps the first sensor CM1. For example, the optical sheet 330 may not overlap the first sensor CM1. However, as described above, the optical sheet 330 may not have an opening and can at least partially overlap the first sensor CM1 or the second light guide portion 320b in the stacking direction.

The bottom surface BS1 of the light guide plate 320 can be located adjacent to the bottom cover 410. The bottom surface BS1 of the light guide plate 320 can be located closer to the bottom cover 410 than the upper surface US1 is. In addition, a first reflective sheet RF1 can be disposed on the bottom surface BS1 of the light guide plate 320.

The first reflective sheet RF1 can reflect light directed downward from the light guide plate 320 in the light guide plate 320. The first reflective sheet RF1 may not overlap the sloped surface SS1. For example, the first reflective sheet RF1 can be disposed to be misaligned with the sloped surface SS1 in the stacking direction.

Therefore, the first reflective sheet RF1 can also be disposed to be misaligned with the first sensor CM1 overlapping the sloped surface SS1 in the stacking direction. In other words, the first reflective sheet RF1 can be disposed to be spaced apart from the first sensor CM1. The first reflective sheet RF1 can correspond to the above-describe “reflective sheet.”

The sloped surface SS1 can be connected to the upper surface US1 and the bottom surface BS1. For example, the sloped surface SS1 can be located between the upper surface US1 and the bottom surface BS1. In addition, the sloped surface SS1 can correspond to the chamfered portion of the light guide plate 320.

The sloped surface SS1 of the light guide plate 320 may not overlap the upper surface US1 in the stacking direction. In addition, as described above, the light guide plate 320 can have a protruding area PR extending downward more than the first light guide portion 320a or the bottom surface BS1. In addition, the sloped surface SS1 can be located in the protruding area PR.

According to the embodiment, a thickness d1 of the light guide plate 320 under the first display area DA1 can be reduced by the protruding area PR, thereby miniaturizing the display device. In addition, even when an incident area of the first reflector 340 according to an angle of view of the first sensor CM1 increases, the thickness of the light guide plate 320 can be reduced or prevented from increasing through the protruding area. For example, since the light guide plate 320 has the protruding area PR in a partial area, the light guide plate 320 can maintain lightweight and miniaturization despite any change in incident angle of the first reflector 340.

The bottom cover 410 can include a base portion 411 and a protruding portion 412. The protruding portion 412 can be located in one area of the bottom cover 410 and can be a portion extending downward from the base portion 411. For example, the first sensor CM1 and the second sensor CM2 can be accommodated in the protruding portion 412. An accommodation space for the first sensor CM1 and the second sensor CM2 can be easily secured by the protruding portion 412. The protruding portion 412 can be located at the edge the base portion 411 or inside the base portion 411. The protruding portion 412 can be surrounded by the base portion 411. For example, the protruding portion 412 can be located inside the edge of the base portion 411. A location of the protruding portion 412 can be variously adjusted corresponding to locations of the first sensor CM1 and the second sensor CM2.

Corresponding to the protruding portion 412 described above, the light guide plate 320 can have the protruding area PR extending downward. Therefore, a thickness d2 or the maximum thickness of the light guide plate 320 at the sloped surface SS1 can be greater than the thickness d1 of the light guide plate 320 at the bottom surface BS1 (or in the first display area). Under the second display area DA2, the sloped surface SS1 can be located in the protruding area PR.

Corresponding to the protruding area PR, the light guide plate 320 can include an extension surface PS1 extending downward from the bottom surface BS1. The thickness of the light guide plate 320 can be increased due to the extension surface PS1.

As the sloped surface SS1 is closer to the second sensor CM2, a separation distance from the first sensor CM1 can be decreased. In addition, as the light guide plate 320 is closer to the second sensor CM2 under the sloped surface SS1, the thickness d2 of the light guide plate 320 can be decreased. According to a sloped structure of the sloped surface SS1, the first reflector 340 disposed on the sloped surface SS1 can reflect the light LG1 output from the light source downward toward the first sensor CM1.

The first light-transmitting member PR1 can be located on the first reflector 340. The first light-transmitting member PR1 can overlap the sloped surface SS1 in the stacking direction. In addition, the first light-transmitting member PR1 can be located at the other side of the light guide plate 320.

For example, the first light-transmitting member PR1 can be located between the light guide plate 320 and a support frame G. In addition, the first light-transmitting member PR1 can be located between the first reflector 340 and the second sensor CM2. The first light-transmitting member PR1 can be located between the first reflector 340 and the display panel 100. In addition, the first light-transmitting member PR1 can be located between the sloped surface SS1 and the display panel 100. In addition, the first light-transmitting member PR1 can be disposed between the second light-emitting unit of the second sensor and the first reflector 340. Therefore, it is possible to suppress the introduction of foreign substances, etc. into the first reflector 340 through which infrared wavelength light is transmitted and from which visible wavelength light is reflected. As a result, improved sensing sensitivity can be maintained and the dark areas can be easily reduced.

The support frame G can be disposed at an end portion of the light guide plate 320. The support frame G can surround the light guide plate 320, etc. as described above. In addition, the support frame G can be coupled to the bottom cover 410 (or the top cover) by a fixing member. Alternatively, the support frame G can be coupled to the bottom cover 410 by various coupling structures (e.g., passing through, etc.). For example, the bottom cover 410 can pass through at least a partial area of the support frame G.

In addition, a second adhesive member AD2 can be located between the support frame G and the display panel 100. In particular, the second adhesive member AD2 can overlap the non-display area of the display panel 100. The second adhesive member AD2 can have a form of a tape, etc.

A second reflective sheet can be further disposed between the extension surface PS1 and an inner surface of the protruding portion 412 facing the extension surface PS1.

The protruding area PR can be a member separated from the light guide plate 320. Therefore, in order to couple the protruding area PR to the light guide plate 320, an additional adhesive member can be located between the protruding area PR and the first light guide portion 320a.

The display device according to the embodiment can include a substrate SB provided with the first sensor CM1 and the second sensor CM2. The substrate SB can include a first substrate SB1 and a second substrate SB2. The first substrate SB1 and the second substrate SB2 can be configured in a separated, connected or coupled structure. In addition, the first sensor CM1 can be disposed on the first substrate SB1. The second sensor CM2 can be disposed on the second substrate SB2. In addition, the substrate SB can be located inside or outside the bottom cover 410. Alternatively, at least a portion of the substrate SB can overlap the bottom cover 410 in the first direction (the X-axis direction).

The first substrate SB1 and the second substrate SB2 can be electrically connected to a sensor driver. Therefore, as described below, control signals of the first sensor CM1 and the second sensor CM2 can be applied to the first substrate SB1 and the second substrate SB2 depending on whether the sensor is driven (on/off).

The first substrate SB1 and the second substrate SB2 can be disposed to intersect each other. The second substrate SB2 can be disposed to have a predetermined angle with respect to the first substrate SB1. In addition, an upper surface of the second substrate SB2 and an upper surface of the first substrate SB1 may not be parallel to each other. For example, the second substrate SB2 can be disposed perpendicular to the first substrate SB1.

The first light-emitting unit TX1 of the first sensor CM1 and the second light-emitting unit TX2 of the second sensor CM2 can be misaligned in the first direction (the X-axis direction). In the embodiment, the first direction can correspond to a direction from the light source toward the light guide plate 320. In addition, the first light-receiving unit RX1 of the first sensor CM1 can be misaligned with the second light-receiving unit RX2 of the second sensor CM2 in the first direction.

For example, the second light-emitting unit TX2 can be located adjacent to the first light-receiving unit RX1 which is an infrared camera. The first light-emitting unit TX1 can be located adjacent to the second light-receiving unit RX2 which is an RGB camera. In addition, the first sensor CM1 and the second sensor CM2 can emit light in directions intersecting each other. With this configuration, each of the light emitted from the first light-emitting unit TX1 and the second light-emitting unit TX2 can be incident on different surfaces of the first reflector 340. Therefore, the sensing accuracy can be increased. In addition, the second sensor CM2 can be located between the first sensor CM1 and the end portion of the display panel 100. Thus, a size of the second display area DA2 can be reduced or minimized. For example, an area in which the dark area needs to be reduced can be reduced.

In a modified example, the sloped surface SS1 can overlap not only the second display area DA2 overlapping the first sensor CM1, but also an area overlapping the opposing light incident portion of the first display area DA1. For example, the sloped surface SS1 can be located over the entire opposing light incident portion. For example, the sloped surface SS1 can have an area other than the area overlapping the first sensor CM1. In addition, the sloped surface SS1 can overlap an area overlapping the opposing light incident portion of the first display area and the second display area. Therefore, the first reflector 340 can also be located over the entire opposing light incident portion. For example, the first reflector 340 can also be located in an area other than the area overlapping the first sensor CM1. In addition, the first reflector 340 can overlap the area overlapping the opposing light incident portion of the first display area and the second display area. With this configuration, even when the amount of light guided to the opposing light incident portion is small, light can be reflected to the display panel 100 by the first reflector 340. Therefore, luminance can be uniform through the entirety of the display panel.

Referring to FIG. 5, a method for driving the display device according to the embodiment can include determining whether the display device is driven (S11), determining whether a sensor is operated (S12), operating an auxiliary light source (S13 and S14), and determining a light transmitting mode of a liquid crystal layer (S15).

In the determining of whether the display device is driven (S11), whether the display device is in a turned-on state or a turned-off state can be determined. For example, when power is supplied to the display device, driving of the display device according to the embodiment can start.

In the determining of whether the sensor is operated S12, a host can transmit a driving signal of the second sensor to a sensor controller. The sensor controller can control the driving of the first sensor and the second sensor. Based on the received driving signal, the second sensor can perform on/off operations.

The determining of whether the auxiliary light source is operated (S13 and S14) can be determined according to whether the second sensor is driven. The host can transmit a control signal of the second light-emitting unit synchronized with the driving signal of the second sensor to the sensor controller. Therefore, the sensor controller can determine whether the second light-emitting unit is operated (on/off) according to the driving of the second sensor. For example, when the driving of the second sensor is turned on and operates in a shooting mode, the driving of the second light-emitting unit (auxiliary light source) can be turned off. In addition, when the driving of the second sensor is turned off and the shooting mode ends, the second light-emitting unit (auxiliary light source) can be turned on to eliminate the dark area of the second display area. In this case, the display device can perform a full-screen display. For example, the display device can display an image without a dark area even in the second display area during a period of a non-shooting mode.

The determining of the light transmitting mode of the liquid crystal layer (S15) can be performed when the auxiliary light source is turned off. The host can transmit a signal synchronized with the driving signal of the second sensor to a panel driver. The panel driver can drive a panel according to the received control signal.

For example, when the second sensor operates and the auxiliary light source is turned off, the panel driver can drive the liquid crystal layer in the light transmitting mode. The light transmitting mode can be defined as driving the liquid crystal so that the light transmission amount of the display panel is improved or maximized. The light transmitting mode is intended to improve or maximize the amount of light incident on an image sensor and can be distinguished from a driving mode in which the transmittance of the panel is adjusted to implement an image.

The light transmitting mode can be performed only in the second display area. When the second display area operates in the light transmitting mode, the first display area can operate in the driving mode for displaying an image. Therefore, power efficiency can be increased, and image sensing can be performed accurately.

In the various embodiments, modifications, and use examples below, the contents described in the embodiments, etc. described in the present detailed description can be applied except for the contents described below.

Referring to FIG. 6, in the present usage example, the substrate SB can include the first substrate SB1 and the second substrate SB2 as described above. The first substrate SB1 and the second substrate SB2 can be separated. For example, the first substrate SB1 and the second substrate SB2 can be disposed to be spaced apart by a predetermined distance (gap) in the first direction.

The first substrate SB1 can be located inside or outside the protruding portion 412 of the bottom cover 410. For example, at least a portion of the first substrate SB1 can be located outside the protruding portion 412. In addition, the second substrate SB2 can be located inside or outside the protruding portion 412. For example, at least a portion of the second substrate SB2 can be located outside the protruding portion 412.

At least a portion of the bottom cover 410 or the protruding portion 412 can be present between the first substrate SB1 and the light guide plate 320. In addition, at least a portion of the bottom cover 410 or the protruding portion 412 can be present between the second substrate SB2 and the light guide plate 320. Therefore, a gap between the light guide plate 320 and the bottom cover 410 can be reduced. Therefore, a thickness of the display device can be reduced.

In addition, movement of either the first substrate SB1 or the second substrate SB2 can be facilitated. For example, when movement of the first sensor CM1 on the first substrate SB1 is required or movement of the second sensor CM2 on the second substrate SB2 is required, alignment, etc. can be easily performed by moving each substrate. In addition, repair due to offset alignment can also be more easily performed.

Referring to FIG. 7, in the present usage example, the substrate SB can include the first substrate SB1 and the second substrate SB2 as described above. The first substrate SB1 and the second substrate SB2 can be formed separately or integrally.

The display device can include a flat layer AM disposed to cover the second sensor CM2 on the second substrate SB2. The flat layer AM can cover a portion of side surfaces or an upper surface of the second sensor CM2. Accordingly, contact between the second sensor CM2 and the first light-transmitting member PR1 can be reduced or prevented or location adjustment can be easily achieved. In addition, light emitted from the second sensor CM2 can be efficiently incident on the first light-transmitting member PR1. In addition, the flat layer AM can protect the second sensor CM2 and the first light-transmitting member PR1 from an external impact, thereby improving the reliability of the display device. In addition, heat generated from the second sensor CM2 can be easily transferred to the outside, the second substrate SB2, etc.

The display device can include a fourth adhesive member AD4 disposed between the first light guide portion 320a and the second light guide portion 320b. The thicknesses of the first light guide portion 320a and the second light guide portion 320b can be easily adjusted by the fourth adhesive member AD4. In addition, the manufacturing and assembly of the light guide plate can be easily accomplished.

Referring to FIG. 8, in the present usage example, the substrate SB can include the first substrate SB1 and the second substrate SB2 as described above. The first substrate SB1 and the second substrate SB2 can be formed separately or integrally.

In this case, the second light-receiving unit RX2 can be disposed on the second substrate SB2 under the second display area DA2. In addition, the second light-receiving unit RX2 can be located in an area between the first light-emitting unit TX1 and the first light-receiving unit RX1 on the first substrate SB1.

In addition, the second light-emitting unit TX2 or an auxiliary light source can be located in an area adjacent to the second display area DA2. The second light-emitting unit TX2 or the auxiliary light source can be located in an area of the light opposing portion area and can receive power through a separate circuit board. Therefore, light emitted from the second light-emitting unit TX2 in the area of the opposing light incident portion can be reflected to the display panel 100 by the first reflector 340. In addition, external light or visible light reflected from an object can be provided back to the second light-receiving unit RX2. With this configuration, the reduction in the dark area and the improvement in light uniformity for the second display area DA2 can be achieved.

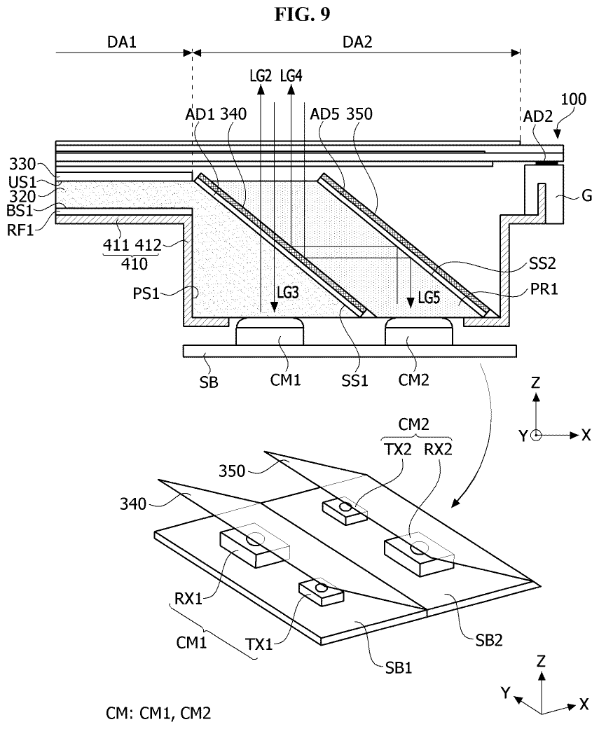

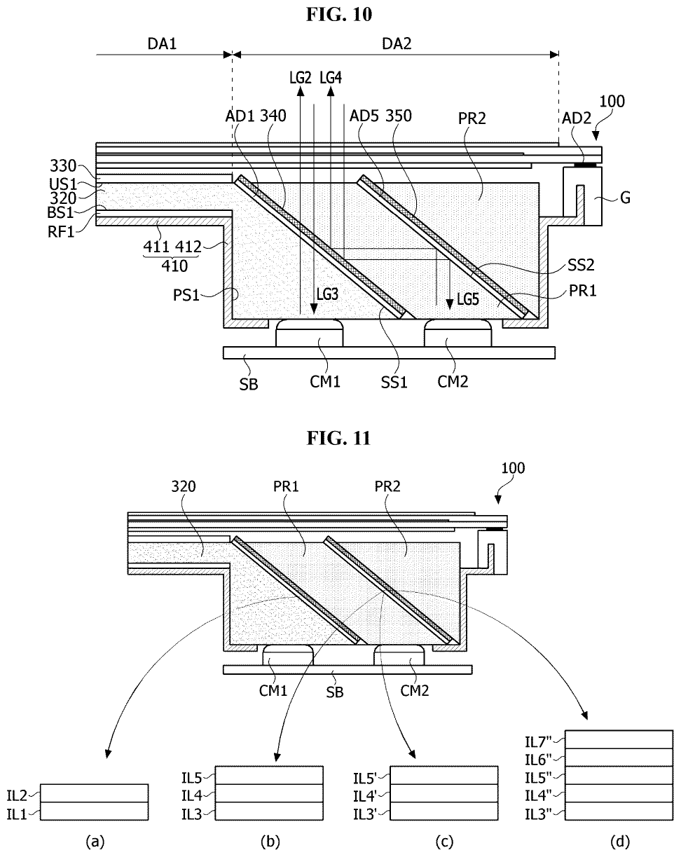

FIG. 9 is a cross-sectional view of a display device according to a second embodiment, FIG. 10 is a modified example of FIG. 9, (a) of FIG. 11 shows a layer structure between a light guide plate and a first light-transmitting member, and (b) to (d) of FIG. 11 show various layer structures between the first light-transmitting member and a second light-transmitting member.

Referring to FIG. 9, the display device according to the second embodiment can include the display panel 100, the backlight unit 300, the sensor CM, and a case member. In addition, the backlight unit 300 can further include a first light-transmitting member PR1, a second reflector 350, and a fifth adhesive member AD5. In addition, except for the contents described below, the contents described in other embodiments, etc. can be applied to the present embodiment.

In the present embodiment, the light guide plate 320 can have the sloped surface SS1 overlapping the second display area DA2. In addition, the first reflector 340 can be disposed on the sloped surface SS1. In addition, the first light-transmitting member PR1 can be disposed on the sloped surface SS1 or the first reflector 340. At least portions of the first reflector 340, the first light-transmitting member PR1, and the second reflector 350 can overlap in the first direction.

In addition, the second reflector 350 can be disposed on the first light-transmitting member PR1. The second reflector 350 can be disposed on a sloped surface SS2 of the first light-transmitting member PR1. Therefore, the second reflector 350 can also be disposed obliquely in the second display area DA2. In particular, the second reflector 350 can be disposed obliquely in the direction (in the first direction) toward the light guide plate from the light source 310. In addition, the second reflector 350 can be parallel to the first reflector 340. With this configuration, light reflected by the second reflector 350 can be provided to the first reflector 340, or the opposite optical path can be formed.

The second reflector 350 can reflect light in the visible wavelength band like the first reflector 340. The second reflector 350 can be formed of a material that is the same as or differs from the first reflector 340. For example, when the first reflector 340 is a filter, the second reflector 350 can include a mirror performing reflection. For example, the second reflector 350 can be a reflector made of a metal (e.g., silver (Ag)) having a high light reflectivity.

The first sensor CM1 can be located under the first reflector 340. The first sensor CM1 can overlap the first reflector 340. The second sensor CM2 can be located under the second reflector 350. The second sensor CM2 can overlap the second reflector 350.

With this configuration, light emitted from the first sensor CM1 can transmit the first reflector 340, and light reflected from an object can also transmit the first reflector 340 and can be provided to the first sensor CM1.

In addition, light emitted from the second sensor CM2 can be reflected from the second reflector 350 to the first reflector 340 and then reflected from the first reflector 340 to the second display area (or the display panel). Conversely, light reflected from the outside or an object can be reflected to the second sensor CM2 through the first reflector 340 and the second reflector 350. Therefore, since sensing is performed through the first sensor CM1 and the second sensor CM2, the dark area of the second display area DA2 can be reduced.

The fifth adhesive member AD5 can be disposed between the second reflector 350 and the sloped surface SS2 of the first light-transmitting member PR1. The fifth adhesive member AD5 can be located on the sloped surface SS2 of the first light-transmitting member PR1. Therefore, the second reflector 350 and the first light-transmitting member PR1 can be coupled by the fifth adhesive member AD5.

The first substrate SB1 and the second substrate SB2 can be disposed in parallel. The first substrate SB1 and the second substrate SB2 can be disposed adjacent to each other in the first direction or in the second direction perpendicular to the first direction (or in the stacking direction). For example, the first substrate SB1 and the second substrate SB2 can have coplanar upper surfaces.

At least portions of the first sensor CM1 and the second sensor CM2 can overlap in the first direction. In addition, at least portions of the first sensor CM1 and the second sensor CM2 can overlap in the stacking direction and the second direction perpendicular to the first direction. In the present embodiment, the first sensor CM1 and the second sensor CM2 can be sequentially disposed in the first direction, and the first substrate SB1 and the second substrate SB2 can also be sequentially disposed in the first direction. The first substrate SB1 and the second substrate SB2 can be configured as one substrate SB.

Therefore, the first sensor and the second sensor are both disposed on one substrate or on the same surface, and thus assembly of the substrate and the sensor can be easily performed. In addition, light can be concentrated in an area adjacent to a bezel or non-display area outside the second display area and may not be emitted.

Referring to FIG. 10, the display device can further include a second light-transmitting member PR2. The second light-transmitting member PR2 can be disposed on the sloped surface SS1 of the first light-transmitting member PR1. In addition, the second reflector 350 can be disposed between the second light-transmitting member PR2 and the first light-transmitting member PR1. For example, the first reflector 340, the first light-transmitting member PR1, the second reflector 350, and the second light-transmitting member PR2 can overlap in the first direction.

The second light-transmitting member PR2 can be located above the sloped surface SS2 of the first light-transmitting member PR1 and the second reflector 350. In addition, the second light-transmitting member PR2 can have a sloped surface being in contact with the second reflector 350. In addition, the second light-transmitting member PR2 can surround the second reflector 350. In addition, since a portion of the second light-transmitting member PR2 can be in contact with the bottom cover 410, the light guide plate 320, the first reflector 340, the first light-transmitting member PR1, the second reflector 350, and the second light-transmitting member PR2 can be provided on the bottom cover 410 with increased bonding strength. In addition, it is possible to suppress the introduction of foreign substances, etc. into the second reflector 350 through which infrared wavelength light is transmitted. Therefore, improved sensing sensitivity can be maintained.

FIG. 11 is a view showing a layer structure between a light guide plate and a first light-transmitting member and various layer structures between the first light-transmitting member and a second light-transmitting member.

Referring to (a) of FIG. 11, a first intermediate layer IL1 and a second intermediate layer IL2 can be disposed on the sloped surface of the light guide plate as described above. The first intermediate layer IL1 can be a first adhesive member. The second intermediate layer IL2 can be a first reflector. In addition, an adhesive member identical to the first intermediate layer IL1 can be further disposed on the second intermediate layer IL2. For example, the first intermediate layer IL1, the second intermediate layer IL2, and the first intermediate layer IL1 can be sequentially located between the sloped surface of the light guide plate and the first light-transmitting member PR1.

Prior to the description of (b) to (d) of FIG. 11, a plurality of intermediate layers can be present between the first light-transmitting member PR1 and the second light-transmitting member PR2 in the display device according to the embodiment. Among the plurality of intermediate layers, a layer corresponding to the “adhesive member” can be located adjacent to the first light-transmitting member PR1 or the second light-transmitting member PR2. In addition, one layer of the plurality of intermediate layers can correspond to the second reflector. In addition, another layer among the plurality of intermediate layers can be an absorbing layer. In this case, the layer corresponding to the second reflector can be located closer to the first light-transmitting member PR1 than the layer corresponding to the absorbing layer is.

Referring to (b) of FIG. 11, a third intermediate layer IL3, a fourth intermediate layer IL4, and a fifth intermediate layer IL5 can be located between the first light-transmitting member PR1 and the second light-transmitting member PR2. The third intermediate layer IL3 can be in contact with the first light-transmitting member PR1. In addition, the fifth intermediate layer IL5 can be in contact with the second light-transmitting member PR2.

The third intermediate layer IL3 can be the second reflector. The fourth intermediate layer IL4 can be an absorbing layer. For example, the fourth intermediate layer IL4 can be formed of a material absorbing light emitted from the second sensor. The fourth intermediate layer IL4 can be a black-coated layer. In addition, the fifth intermediate layer IL5 can be a fifth adhesive member. Therefore, the fifth intermediate layer IL5 can provide improved bonding force between the fourth intermediate layer IL4 and the second light-transmitting member PR2.

Referring to (c) of FIG. 11, a third intermediate layer IL3′, a fourth intermediate layer IL4′, and a fifth intermediate layer IL5′ can be located between the first light-transmitting member PR1 and the second light-transmitting member PR2.

The third intermediate layer IL3′ can be a fifth adhesive member. The third intermediate layer IL3′ can provide increased bonding strength between the fourth intermediate layer IL4′ and the first light-transmitting member PR1.

The fourth intermediate layer IL4′ can be the second reflector. Therefore, the light emitted from the second sensor can be reflected by the fourth intermediate layer IL4′ and provided to the first reflector.

In addition, the fifth intermediate layer IL5′ can be an absorbing layer. For example, the fifth intermediate layer IL5′ can be formed of a material absorbing light emitted from the second sensor. The fifth intermediate layer IL5′ can be a black-coated layer.

Referring to (d) of FIG. 11, a third intermediate layer IL3″, a fourth intermediate layer IL4″, a fifth intermediate layer IL5″, a sixth intermediate layer IL6″, and a seventh intermediate layer IL7″ can be located between the first light-transmitting member PR1 and the second light-transmitting member PR2.

The third intermediate layer IL3″ and the seventh intermediate layer IL7″ can correspond to adhesive members (e.g., the fifth adhesive member). Therefore, the increased bonding strength between the fourth intermediate layer IL4″ and the first light-transmitting member PR1 can be provided. In addition, the improved bonding force between the sixth intermediate layer IL6″ and the second light-transmitting member PR2 can be provided.

The fifth intermediate layer IL5″ can be the second reflector. Therefore, light emitted from the second sensor can be reflected by the fifth intermediate layer IL5″ and provided to the first reflector.

The sixth intermediate layer IL6″ can including an optical film or the like as a base member. Therefore, the sixth intermediate layer IL6″ can provide a supporting force, optical performance, etc.

The seventh intermediate layer IL7″ can be an absorbing layer. For example, the seventh intermediate layer IL7″ can be formed of a material absorbing light emitted from the second sensor. The seventh intermediate layer IL7″ can be a black-coated layer.

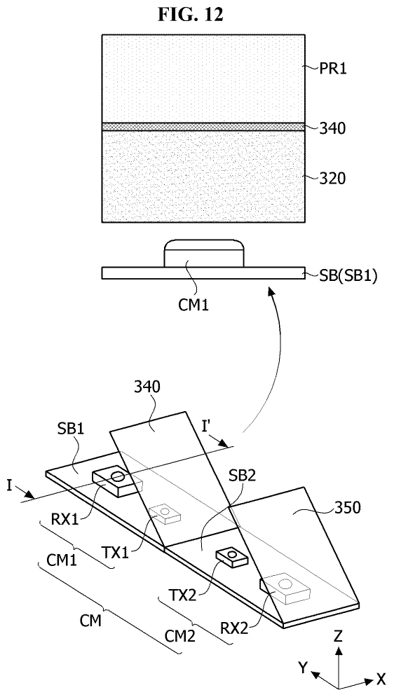

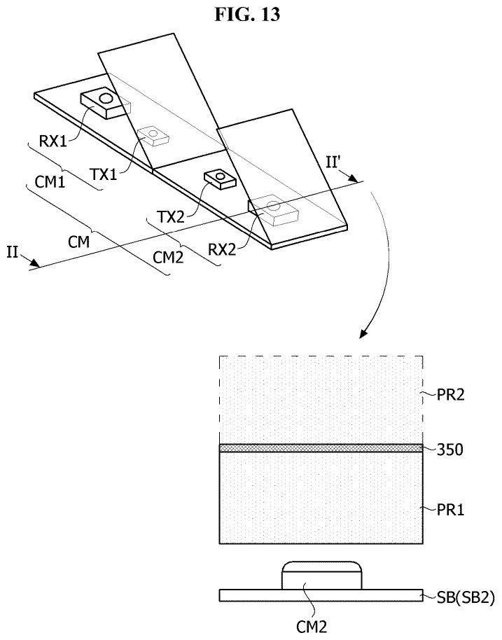

FIG. 12 is a modified example of FIG. 9 (lower drawing) and a cross-sectional view along line I-I′ of FIG. 9 (upper drawing). FIG. 13 is a modified example of FIG. 9 (upper drawing) and a cross-sectional view along line II-II′ of FIG. 13 (lower drawing).

Referring to FIGS. 12 and 13, the first substrate SB1 and the second substrate SB2 can be disposed in parallel to each other. The first substrate SB1 and the second substrate SB2 can be disposed adjacent to each other in the second direction (in the Y-axis direction). For example, the first substrate SB1 and the second substrate SB2 can have coplanar upper surfaces. The direction in which the first substrate SB1 and the second substrate SB2 are disposed in parallel can be perpendicular to the direction in which the first substrate SB1 and the second substrate SB2 are disposed in parallel in FIG. 9.

At least portions of the first sensor CM1 and the second sensor CM2 can overlap in the second direction (in the Y-axis direction). In the present embodiment, the first sensor CM1 and the second sensor CM2 can be sequentially disposed in the second direction (in the Y-axis direction), and the first substrate SB1 and the second substrate SB2 can also be sequentially disposed in the second direction (in the Y-axis direction).

The first reflector 340 and the second reflector 350 can be disposed obliquely with respect to the second direction (the Y-axis direction). The first light-transmitting member PR1 can be located between the first reflector 340 and the second reflector 350. In addition, the second light-transmitting member PR2 can be located on the second reflector 350. Therefore, at least portions of the first reflector 340, the first light-transmitting member PR1, and the second reflector 350 (or the second light-transmitting member) can overlap in the second direction. In addition, the first light-receiving unit RX1, the first light-emitting unit TX1, the second light-receiving unit RX2, and the second light-emitting unit TX2 can be disposed in a line in one direction.

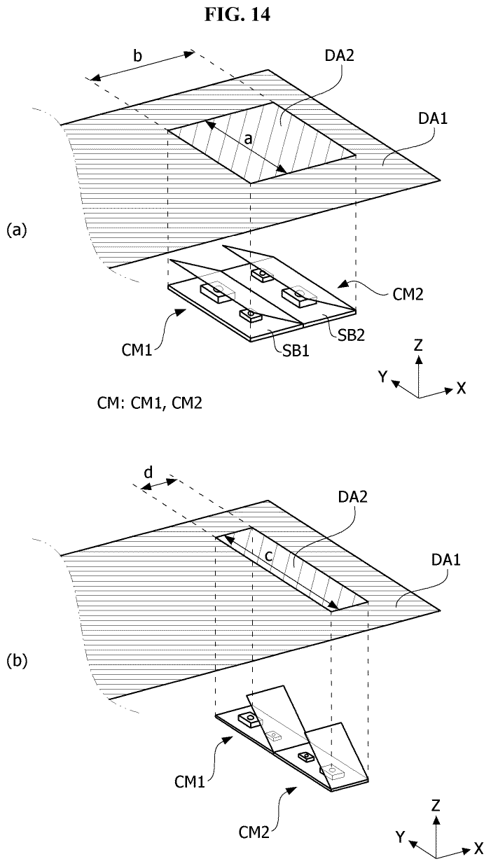

FIG. 14 is a view showing a second display area according to various examples of the display device according to the second embodiment.

Referring to (a) of FIG. 14, as described in FIG. 9, the first substrate SB1 and the second substrate SB2 can be disposed in parallel so that long side surfaces thereof face each other. The first substrate and the second substrate can be disposed adjacent to each other in the first direction (the X-axis direction). For example, the first substrate SB1 and the second substrate SB2 can have coplanar upper surfaces.

At least portions of the first sensor CM1 and the second sensor CM2 can overlap in the first direction. The first sensor CM1 and the second sensor CM2 can be sequentially disposed in the first direction. In addition, the first substrate SB1 and the second substrate SB2 can also be sequentially disposed in the first direction.

In addition, the display area DA of the display panel 100 can include the first display area DA1 and the second display area DA2. The second display area DA2 can be located above the sensor CM or the first substrate and the second substrate. For example, the second display area DA2 can be an area corresponding to or overlapping the sensor CM or the first substrate and the second substrate.

In addition, corresponding to structures of the first substrate and the second substrate (or the first sensor and the second sensor), the second display area DA2 can have a length a and a width b. The length can be a distance extended in the second direction. The length a and the width b of the second display area DA2 can be the same or substantially same. Alternatively, the length a and the width b of the second display area DA2 can have a size difference less than 20%.

Referring to (b) of FIG. 14, as described in FIG. 12, the first substrate SB1 and the second substrate SB2 can be disposed in parallel so that short side surfaces thereof face each other. The first substrate SB1 and the second substrate SB2 can be disposed adjacent to each other in the second direction (in the Y-axis direction). In addition, the first substrate SB1 and the second substrate SB2 can have coplanar upper surfaces.

At least portions of the first sensor CM1 and the second sensor CM2 can overlap in the second direction (in the Y-axis direction). The first sensor CM1 and the second sensor CM2 can be sequentially disposed in the second direction (the Y-axis direction). In addition, the first substrate SB1 and the second substrate SB2 can also be sequentially disposed in the second direction (the Y-axis direction).

In addition, the display area DA of the display panel 100 can include the first display area DA1 and the second display area DA2. The second display area DA2 can be disposed above the sensor CM, or located above the first substrate and the second substrate. For example, the second display area DA2 can correspond to the sensor CM, or can be an area corresponding to or overlapping the first substrate and the second substrate.

In addition, corresponding to the structures of the first substrate and the second substrate (or the first sensor and the second sensor), the second display area DA2 can have a length c and a width d. The length can be a distance extended in the second direction. The length c and the width d of the second display area DA2 can differ. The length c of the second display area DA2 can be greater than the width d. For example, in the second display area DA2, the length c can be 1.5 times or more the width d.

In this way, a size and a structure of the second display area DA2 can change depending on the locations of the first sensor and the second sensor (or the first substrate and the second substrate). Therefore, the structure of the second display area DA2 can be freely changed in design corresponding to a structure of the display device, etc.

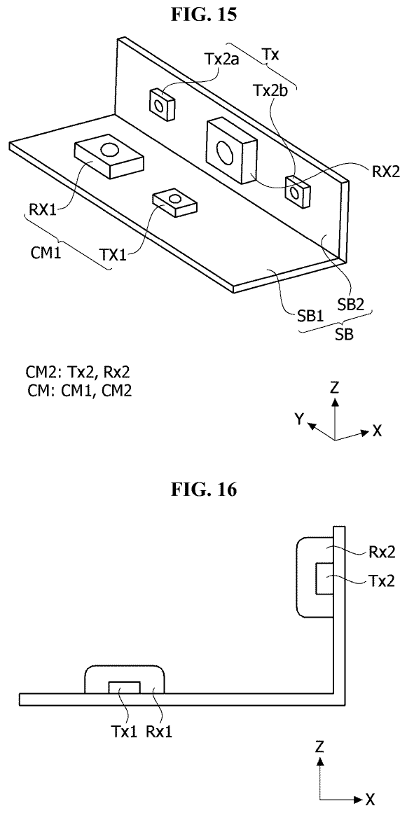

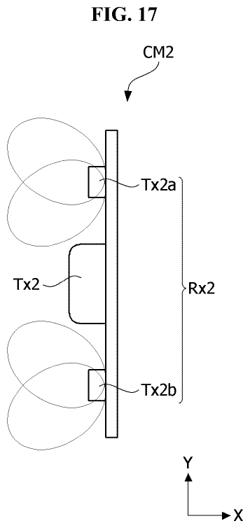

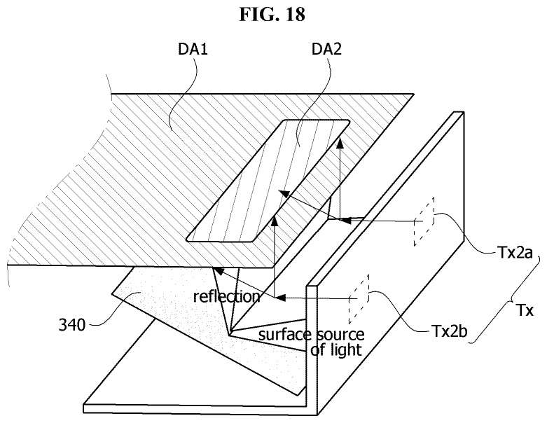

FIG. 15 is a first usage example of a first sensor and a second sensor in a display device according to the embodiment, FIG. 16 is a side view of FIG. 15, FIG. 17 is a plan view of FIG. 15, and FIG. 18 is a view for describing effects of the first usage example of the first sensor and the second sensor in the display device according to the embodiment.

Referring to FIGS. 15 to 18, as described above, the display device can include the substrate SB provided with the first sensor CM1 and the second sensor CM2. The first substrate SB1 and the second substrate SB2 of the substrate SB can be configured in a separated, connected or coupled structure.

The first sensor CM1 can be disposed on the first substrate SB1. The second sensor CM2 can be disposed on the second substrate SB2. In addition, the first substrate SB1 and the second substrate SB2 can be disposed to intersect each other. The second substrate SB2 can be disposed to have a predetermined angle with respect to the first substrate SB1. In addition, an upper surface of the second substrate SB2 may not be parallel to an upper surface of the first substrate SB1. For example, the second substrate SB2 can be disposed perpendicular to the first substrate SB1.

The first light-emitting unit Tx1 of the first sensor CM1 and the second light-emitting unit Tx2 of the second sensor CM2 can be misaligned in the first direction (the X-axis direction). In addition, the first light-receiving unit RX1 of the first sensor CM1 can be misaligned with the second light-receiving unit Rx2 of the second sensor CM2 in the first direction.

For example, the second light-emitting unit Tx2 of the second sensor CM2 can be plural. For example, the second light-emitting unit Tx2 can include a 2-1 light-emitting unit Tx2a and a 2-2 light-emitting unit Tx2b. The second light-receiving unit Rx2 can be located between the 2-1 light-emitting unit Tx2a and the 2-2 light-emitting unit Tx2b.

The 2-1 light-emitting unit Tx2a and the 2-2 light-emitting unit Tx2b can overlap the second light-receiving unit Rx2 in the second direction (the Y-axis direction). In addition, the first light-receiving unit RX1 of the first sensor CM1 can be located corresponding to any one of the plurality of second light-emitting units Tx2.

The 2-1 light-emitting unit Tx2a and the 2-2 light-emitting unit Tx2b can emit light. The light emitted from the 2-1 light-emitting unit Tx2a and the 2-2 light-emitting unit Tx2b can be reflected from the first reflector to the second display area or the display panel. In this case, since the second light-receiving unit Rx2 can be located between the 2-1 light-emitting unit Tx2a and the 2-2 light-emitting unit Tx2b, light that may not be emitted to the upper display panel due to the arrangement of the second light-receiving unit Rx2 can be compensated. For example, the generation of the dark area or the degradation of light uniformity due to the second light-receiving unit Rx2 in the second display area can be improved.

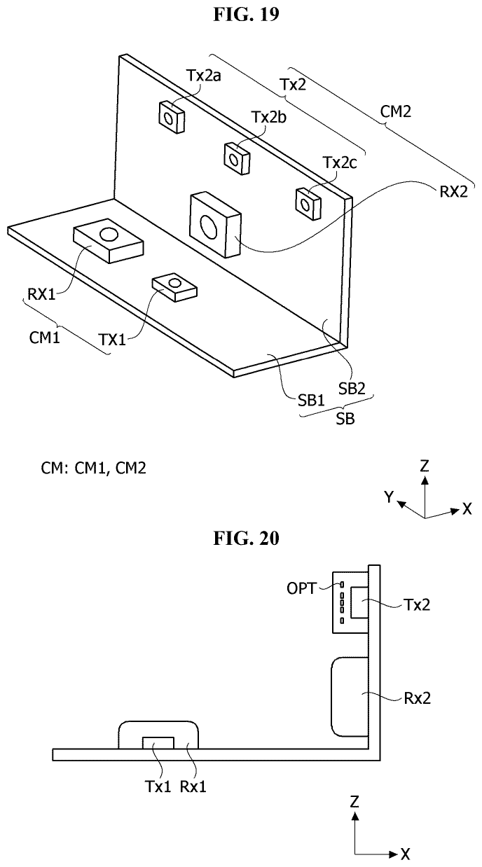

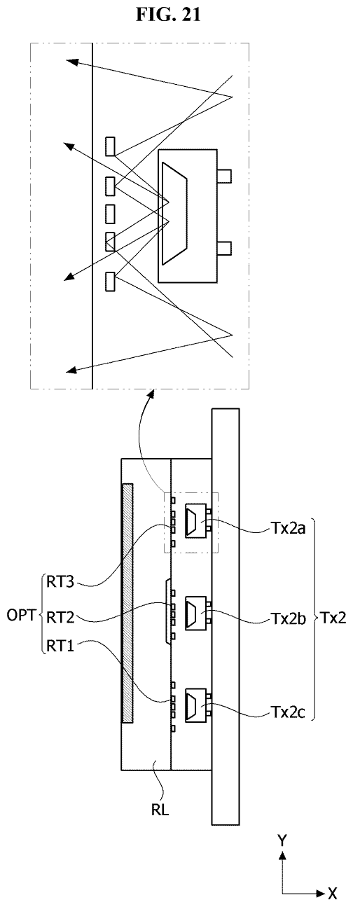

FIG. 19 is a second usage example of the first sensor and the second sensor in the display device according to the embodiment, FIG. 20 is a side view of FIG. 19, and FIG. 21 is a plan view of FIG. 19.

Referring to FIGS. 19 to 21, likewise, the display device can include the substrate SB provided with the first sensor CM1 and the second sensor CM2. The first substrate SB1 and the second substrate SB2 of the substrate SB can be configured in a separated, connected or coupled structure. In addition, the first sensor CM1 can be disposed on the first substrate SB1. The second sensor CM2 can be disposed on the second substrate SB2. In addition, the first substrate SB1 and the second substrate SB2 can be disposed to intersect each other. The second substrate SB2 can be disposed to have a predetermined angle with respect to the first substrate SB1. In addition, an upper surface of the second substrate SB2 may not be parallel to an upper surface of the first substrate SB1. For example, the second substrate SB2 can be disposed perpendicular to the first substrate SB1.

The first light-emitting unit Tx1 of the first sensor CM1 and the second light-emitting unit Tx2 of the second sensor CM2 can be misaligned in the first direction (the X-axis direction). In addition, the first light-receiving unit Rx1 of the first sensor CM1 can be misaligned with the second light-receiving unit Rx2 of the second sensor CM2 in the first direction (the X-axis direction).

In addition, a plurality of the second light-emitting units Tx2 of the second sensor CM2 can be present. For example, the second light-emitting unit Tx2 can include the 2-1 light-emitting unit Tx2a, the 2-2 light-emitting unit Tx2b, and a 2-3 light-emitting unit Tx2c. The second light-receiving unit Rx2 can be disposed to be spaced apart from the 2-1 light-emitting unit Tx2a, the 2-2 light-emitting unit Tx2b, and the 2-3 light-emitting unit Tx2c. For example, the second light-receiving unit Rx2 can be disposed to be spaced apart from the 2-1 light-emitting unit Tx2a, the 2-2 light-emitting unit Tx2b, and the 2-3 light-emitting unit Tx2c in the stacking direction (the Z-axis direction).

The 2-1 light-emitting unit Tx2a, the 2-2 light-emitting unit Tx2b, and the 2-3 light-emitting unit Tx2c can overlap in the second direction (the Y-axis direction). In addition, the 2-1 light-emitting unit Tx2a, the 2-2 light-emitting unit Tx2b, and the 2-3 light-emitting unit Tx2c may not overlap the second light-receiving unit Rx2 in the second direction (the Y-axis direction). For example, the 2-1 light-emitting unit Tx2a, the 2-2 light-emitting unit Tx2b, and the 2-3 light-emitting unit Tx2c can be located to be misaligned with the second light-receiving unit Rx2 in the second direction (the Y-axis direction).

In addition, at least one of the plurality of second light-emitting units Tx2 can overlap the second light-receiving unit Rx2 in the stacking direction (the Z-axis direction). In addition, the plurality of second light-emitting units Tx2 can be symmetrically located with respect to the second light-receiving unit Rx2. For example, the 2-2 light-emitting unit Tx2b can be located between the 2-1 light-emitting unit Tx2a and the 2-3 light-emitting unit Tx2c. In addition, the 2-2 light-emitting unit Tx2b can overlap the second light-receiving unit Rx2. With this configuration, the dark area of the second display area above the sensor CM can be easily reduced, and light uniformity in the first display area and the second display area or in the second display area can be improved.

The second light-emitting unit Tx2 can be surrounded by a resin layer RL. The resin layer RL can be form of a light-transmitting material. In addition, the resin layer RL can improve optical performance, etc. In addition, the second light-emitting unit Tx2 can include an optical element OPT having a plurality of reflective patterns in addition to the light source. For example, the 2-1 light-emitting unit Tx2a can include a first optical element RT1 disposed in an emitting direction of light. The 2-2 light-emitting unit Tx2b can include a second optical element RT2 disposed in the emitting direction of light. In addition, the 2-3 light-emitting unit Tx2c can include a third optical element RT3 disposed in the emitting direction of light.

In addition, the light emitted from the second light-emitting unit Tx2 can be reflected by the optical element OPT. In addition, the emitting direction of light can be controlled through a pattern structure. For example, light emitted from the second light-emitting unit Tx2 can be implemented as a surface light source. Therefore, the dark area for the second display area can be reduced on the basis of a surface rather than a point. For example, each of the plurality of second light-emitting units Tx2 can have an optical element.

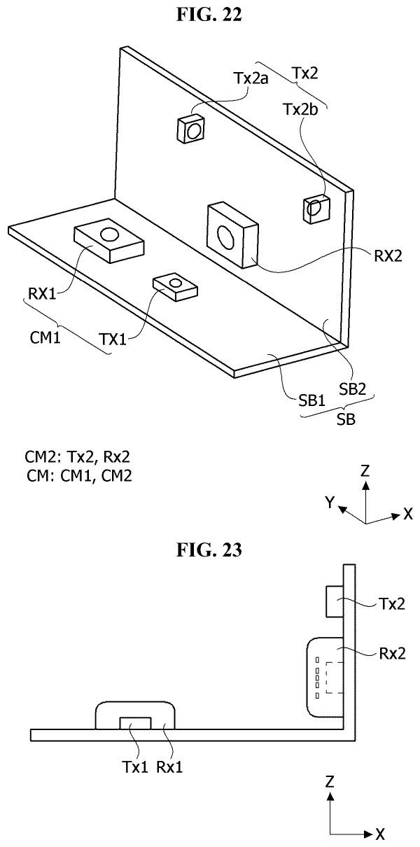

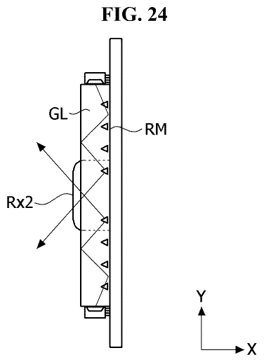

FIG. 22 is a modified example of FIG. 15, FIG. 23 is a side view of FIG. 22, and FIG. 24 is a plan view of FIG. 22.

Referring to FIGS. 22 to 24, in the display device, the first substrate SB1 and the second substrate SB2 of the substrate SB can be configured in a separated, connected or coupled structure. In addition, the first sensor CM1 can be disposed on the first substrate SB1. The second sensor CM2 can be disposed on the second substrate SB2. In addition, the first substrate SB1 and the second substrate SB2 can be disposed to intersect each other. The second substrate SB2 can be disposed to have a predetermined angle with respect to the first substrate SB1. In addition, the first light-emitting unit Tx1 of the first sensor CM1 and the second light-emitting unit Tx2 of the second sensor CM2 can be misaligned in the first direction (the X-axis direction).

A plurality of the second light-emitting units Tx2 of the second sensor CM2 can be present. For example, the second light-emitting unit Tx2 can include the 2-1 light-emitting unit Tx2a and the 2-2 light-emitting unit Tx2b. The second light-receiving unit Rx2 can be located between the 2-1 light-emitting unit Tx2a and the 2-2 light-emitting unit Tx2b. The 2-1 light-emitting unit Tx2a and the 2-2 light-emitting unit Tx2b can overlap in the second direction. In addition, the first light-receiving unit Rx1 of the first sensor CM1 can be located corresponding to any one of the plurality of second light-emitting units Tx2.

The 2-1 light-emitting unit Tx2a and the 2-2 light-emitting unit Tx2b can emit light toward a guiding layer GL. For example, the 2-1 light-emitting unit Tx2a can emit light toward the 2-2 light-emitting unit Tx2b, and the 2-2 light-emitting unit Tx2b can emit light toward the 2-1 light-emitting unit Tx2a.

The second light-emitting unit Tx2 can be surrounded by the guiding layer GL. The guiding layer GL can guide the light emitted from the second light-emitting unit Tx2. In addition, a reflecting member RM can be located in the guiding layer GL. The light emitted from the second light-emitting unit Tx2 can be uniformly guided toward the first reflector by the reflecting member RM. In addition, an emitting path of the light emitted from the second light-emitting unit Tx2 can be controlled by the reflecting member RM.

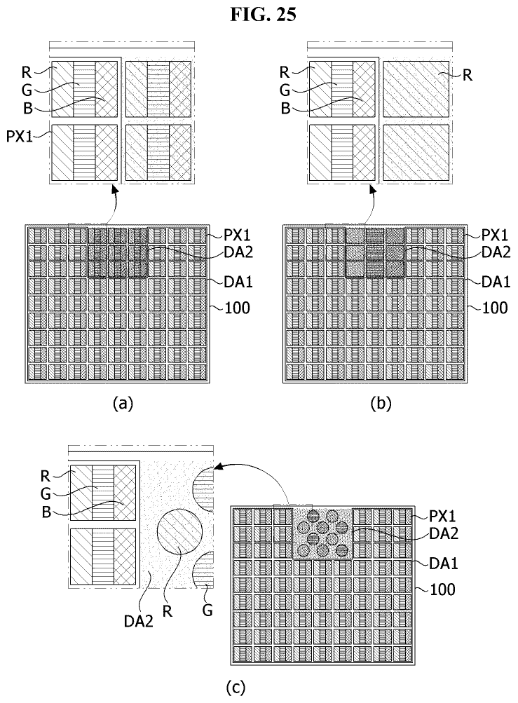

FIG. 25 shows various examples of a pixel structure of a display panel in the display device according to the embodiment of the present disclosure.

In the display device according to the embodiment, the display area of the display panel 100 can include the first display area DA1 and the second display area DA2. A plurality of first pixels PX1 in the first display area DA1 can emit light, and an image can be displayed by the emitted light. In addition, a plurality of second pixels PX2 in the second display area DA2 can also emit light, and an image can be displayed. In this way, the second pixel PX2 can be disposed in the second display area DA2 above the sensor so that a full-screen display can be implemented. In this case, opening areas of the first pixel PX1 and the second pixel PX2 can be the same or different.

Referring to (a) of FIG. 25, the opening areas of the first pixels PX1 and the second pixels PX2 can be the same or substantially same. For example, the first display area DA1 and the second display area DA2 can have a symmetrical structure. Therefore, the display panel can be easily manufactured.

Alternatively, referring to (b) and (c) of FIG. 25, the opening areas of the first pixel PX1 and the second pixel PX2 can be different. For example, the opening areas of the first pixel PX1 and the second pixel PX2 can be different. For example, the opening area for red (or green, blue) light emitted from the first pixel PX1 can be smaller than the opening area for red (or green, blue) light emitted from the second pixel PX2.

A shape of the opening area of a sub-pixel (R, G, or B) in each pixel can vary. For example, the opening area of the sub-pixel can be quadrangular, circular, etc. Therefore, the opening area of the sub-pixel in the first pixel PX1 can differ from the opening area of the sub-pixel in the second pixel PX2, and the shape of the opening area of the sub-pixel in the first pixels PX1 can differ from the shape of the opening area of the sub-pixel in the second pixel PX2.

As a result, as described below, lower transmittance in the second display area can be easily resolved by changing the area, the shape, etc. of the opening area.

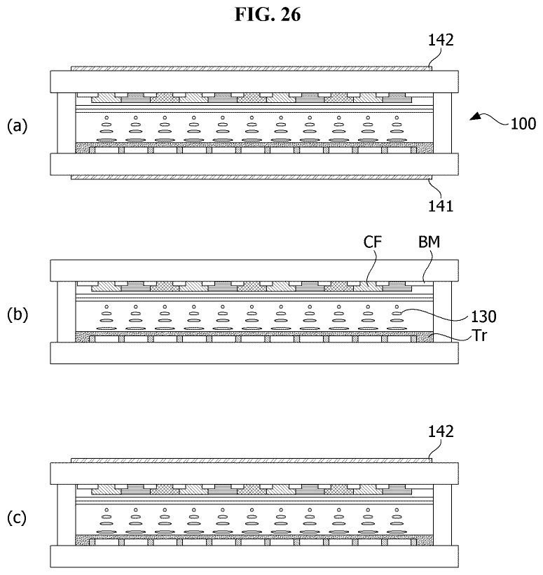

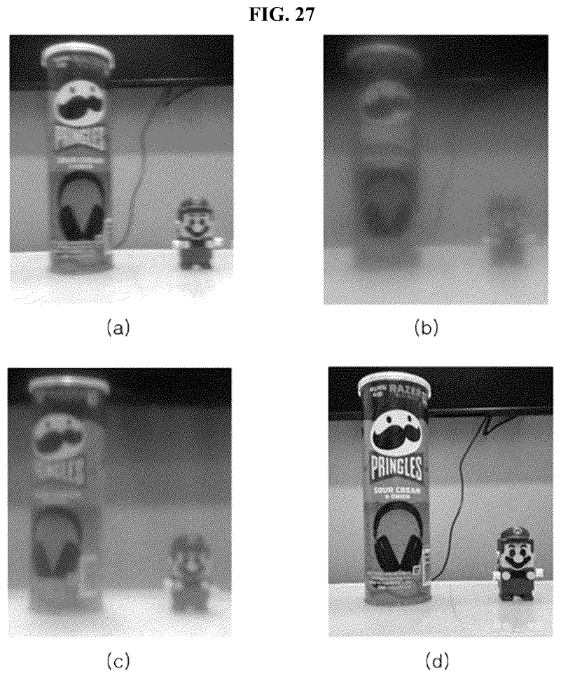

FIG. 26 shows various examples of the display panel and a polarizing plate in the display device according to various experimental examples, and FIG. 27 shows a captured image according to FIG. 26.

Particularly, (a) to (c) of FIG. 26 are cross-sectional views of the second display area during transmittance experiments. Referring to (a) to (c) of FIG. 26, in the display panel 100 according to the embodiment, signal lines and pixels can be provided on an upper surface of a lower substrate. A liquid crystal in the liquid crystal layer 130 can be driven by an electric field generated by a voltage difference between a data voltage supplied to a pixel electrode and a common voltage supplied to a common electrode. The transmission amount of the light incident from the backlight unit can be adjusted by driving the liquid crystal.

The upper polarizing plate 142 can be located on an upper substrate of the display panel 100. In addition, a lower polarizing plate 141 can be located on the lower substrate of the display panel 100. A light transmission axis of the upper polarizing plate 142 can intersect or can be orthogonal to a light transmission axis of the lower polarizing plate 141.

In Experimental Example 1, as shown in (a) of FIG. 26, in the display panel, the upper polarizing plate 142 and the lower polarizing plate 141 described above can both be disposed above and under the display panel 100. In Experimental Example 2, as shown in (b) of FIG. 26, in the display panel, both the upper polarizing plate and the lower polarizing plate can be removed. In Experimental Example 3, as shown in (c) of FIG. 26, in the display panel, the lower polarizing plate can be removed, and the upper polarizing plate can be present.

Also, (d) of FIG. 27 can show an original image. In addition, an image in (a) of FIG. 27 is the image captured by the second sensor through Experimental Example 1 of (a) of FIG. 26. Further, (b) of FIG. 27 is the image captured through Experimental Example 2 of (b) of FIG. 26. In addition, (c) of FIG. 27 is the image captured by the second sensor through Experimental Example 3 of (c) of FIG. 26.

As a result of the experiments, the transmittance was 6.85% in the case of (a) of FIG. 26, 5.7% in the case of (c) of FIG. 26, and 15.7% in the case of (b) of FIG. 26. In this way, it can be seen that image quality deteriorates or is lowered due to decrease in transmittance of light transmitting the second display area and a high haze level by arranging the upper polarizing plate 150 and the lower polarizing plate 140 above/under the second display area.

As a modified example, a non-opening area rather than the opening area of the display panel can be concentrated at one side. For example, the non-opening area such as a data line and a gate line can be concentrated at one edge of one pixel. Therefore, a width or area of the non-opening area between adjacent pixels can be reduced. As a result, a gap between adjacent pixels can be reduced, thereby improving the transmittance of the entirety of the display area. For example, when the pixels are bisected in the horizontal and vertical directions, most of the non-opening area (e.g., 70% or more) can be present in one quadrant. The concentrated structure of the non-opening area can be applied only to the second display area. Therefore, an aperture ratio of the second display area can be higher than an aperture ratio of the first display area. As a result, more accurate sensing or imaging can be achieved by increasing the transmittance in the second display area.

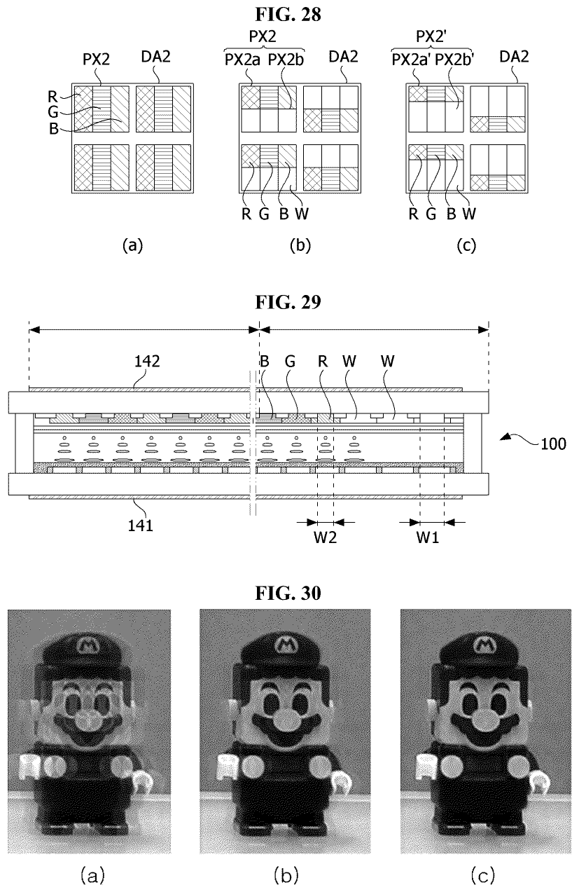

FIG. 28 is a view showing various pixel structures with different aperture ratios in a second display area in the display device, FIG. 29 is a cross-sectional view of the display device having pixels with different aperture ratios according to the embodiment of the present disclosure, and FIG. 30 shows video images according to FIG. 28.

Particularly, (a) of FIG. 28 shows a pixel structure of Experimental Example 1, (b) of FIG. 28 shows the pixel structure of Experimental Example 2, and (c) of FIG. 28 shows the pixel structure of Experimental Example 3. In addition, (a) of FIG. 30 is a video image result through (a) of FIG. 28, and (b) of FIG. 30 is a video image result through (b) of FIG. 28. In addition, (c) of FIG. 30 is a video image result through (c) of FIG. 28.

First, referring to FIG. 29, in order to reduce the degradation of the transmittance of light and the high haze level in the second display area described above, the second pixel of the second display area DA2 in the display panel of the display device according to the embodiment can include a 2-1 pixel and a 2-2 pixel with different areas. Here, the 2-1 pixel can be a sub-pixel for at least one color among red (R), green (G), and blue (B). In addition, the 2-2 pixel can be a sub-pixel for the white color. In experimental examples, an area (opening area) of the 2-1 pixel (R, G, B) can correspond to an area that does not overlap a black matrix on a color filter of the corresponding color. In addition, an area (opening area) of the 2-2 pixel (white, W) can correspond to an area that does not overlap the black matrix without the color filter such as R, G, and B.

Specifically, referring to (a) of FIG. 28, in Experimental Example 1 below, the second pixel PX2 in the second display area DA2 may be formed of only the 2-1 pixel PX2 that is one of red (R), green (G), and blue (B). On the other hand, referring to (b) of FIG. 28, in Experimental Example 2 below, the second pixel PX2 in the second display area DA2 may include the 2-1 pixel PX2a that is one of red (R), green (G), or blue (B) and the 2-2 pixel PX2b that is white (W). In this case, an aperture ratio (opening area) of the 2-1 pixel PX2a may be the same as or substantially the same as the aperture ratio (opening area) of the 2-2 pixel PX2b. Referring to (c) of FIG. 28, in Experimental Example 3 below, the second pixel PX2′ in the second display area DA2 may include the 2-1 pixel PX2a′ that is one of red (R), green (G), or blue (B) and the 2-2 pixel PX2b′ that is white (W). The Experimental Example 3 is the same as or substantially the same as the Experimental Example 2, but the aperture ratio (opening area) of the 2-1 pixel PX2a′ may be smaller than the aperture ratio (opening area) of the 2-2 pixel PX2b′.

Table 1 shows the results of experiments for specifications and transmittance for the structure of FIG. 28 and a reference example.

TABLE 1

| | Ref (Reference | Experimental | Experimental | Experimental |
|---|---|---|---|---|
| Items | Example) | Example 1 | Example 2 | Example 3 |
| Resolution | 1920*RGB*1080 | 1920*RGB*1080 | 3840*2160 | 3840*2160 |
| Transmittance of | 5.0% | 7.9% | 17.0% | 20.1% |
| Panel (Display | | | | |
| Panel) | | | | |
| Upper Polarizing | 78% (Haze 22%) | 98% (Haze <1%) | 98% (Haze <1%) | 98% (Haze <1%) |
| Layer | | | | |
| C/F(Color Filter | 30% | 30% | RGB 30%, | RGB 30%, |
| Ratio) | | | White 100% | White 100% |
| L/C(Liquid Crystal | 90% | 90% | 90% | 90% |
| Layer Ratio) | | | | |
| TFT(Aperture ratio) | 66% | 66% | RGB 33%, | RGB 22%, |
| | | | White 33% | White 44% |
| Lower Polarizing | 36% (Haze 22%) | 45% (Haze <1%) | 45% (Haze <1%) | 45% (Haze <1%) |
| Layer | | | | |

Referring to Table 1 and FIG. 30, comparing Reference Example with Experimental Example 1, it can be seen that the transmittance in the second display area of the display panel is increased by increasing the transmittance of the upper polarizing layer and the lower polarizing layer and lowering the haze level. In addition, comparing Experimental Example 2 with Experimental Example 1 (or Reference Example), it can be seen that the transmittance in the second display area of the display panel is increased since the second display area includes both the 2-1 pixel and the 2-2 pixel.

In addition, comparing Experimental Example 3 with Experimental Example 1 (Experimental Example 2 and Reference Example), it can be seen that the transmittance in the second display area of the display panel is further increased when the second display area includes both the 2-1 pixel and the 2-2 pixel and the aperture ratio (opening area) of the 2-2 pixel is greater than the aperture ratio (opening area) of the 2-1 pixel.

Therefore, in order to increase the transmittance, the upper polarizing plate and the lower polarizing plate overlapping the second display area in the display device according to the embodiment can be removed. In addition, the polarizing plate with a reduced haze level or increased transmittance can be provided. In addition, as shown in FIG. 29, an area (opening area, W1) of the 2-2 pixel (W) in the display panel can be greater than or equal to the area (opening area, W2) of the 2-1 pixel (R, G, B). In addition, in order to further increase the transmittance, the area (opening area, W1) of the 2-2 pixel (W) in the display panel can be greater than the area (opening area, W2) of the 2-1 pixel (R, G, B).

According to embodiments of the present disclosure, an imaging area is not recognized from the outside, a dark area phenomenon in an area where a sensor is disposed can be improved, and light uniformity can be improved. In addition, low power operation can be possible.

In addition, it is possible to achieve miniaturization with a narrow bezel and a reduced thickness.

In addition, one or more embodiments of the present disclosure can provide a display device with increased transmittance.

Although embodiments of the present disclosure have been described in more detail with reference to the accompanying drawings, the present disclosure is not necessarily limited to these embodiments, and various modifications can be made without departing from the technical idea of the present disclosure. Therefore, the embodiments disclosed in the present disclosure are not intended to limit the technical idea of the present disclosure, but intended to describe the same, and the scope of the technical idea of the present disclosure is not limited by these embodiments. Therefore, it should be understood that the above-described embodiments are illustrative and not restrictive in all respects. The scope of the present disclosure should be construed according to the appended claims, and all technical ideas within the equivalent range should be construed as being included in the scope of the present disclosure.

Various and beneficial advantages and effects of the present disclosure are not limited to the above-described contents and will be more readily understood in a process of describing specific embodiments of the present disclosure.

What is claimed is:

1. A display device comprising:
a backlight unit;
a display panel disposed on the backlight unit and including a first display area and a second display area; and
a first sensor and a second sensor disposed under the display panel,
wherein the backlight unit includes:
a light guide plate including a first light guide portion disposed under the first display area and a second light guide portion disposed under the second display area;
a light source configured to radiate light to the light guide plate; and
a first reflector disposed on the second light guide portion, and
wherein the first reflector transmits light emitted from the first sensor and reflects light emitted from the second sensor.

2. The display device of claim 1, wherein the light emitted from the first sensor is emitted to outside by passing through the display panel, reflected from an external object, and received by the first sensor.

3. The display device of claim 1, wherein the light source is disposed at one side of the light guide plate, and the light guide plate includes a sloped surface disposed at another side of the light guide plate being opposite to the one side of the light guide plate, and
wherein the first reflector is disposed on the sloped surface of the light guide plate.

4. The display device of claim 3, wherein the sloped surface of the light guide plate does not overlap an upper surface of the light guide plate.

5. The display device of claim 3, wherein a thickness of the light guide plate decreases toward the other side of the light guide plate along the sloped surface of the light guide plate.

6. The display device of claim 3, further comprising a first light-transmitting member disposed between the sloped surface of the light guide plate and the display panel.

7. The display device of claim 6, wherein the first light-transmitting member is disposed between a second light-emitting unit of the second sensor and the first reflector.

8. The display device of claim 3, wherein the first sensor includes a first light-emitting unit and an infrared camera, and the second sensor includes a second light-emitting unit and an RGB camera.

9. The display device of claim 8, further comprising:
a first substrate on which the first sensor is disposed; and
a second substrate on which the second sensor is disposed.

10. The display device of claim 9, wherein the first substrate and the second substrate are disposed to intersect each other.

11. The display device of claim 10, wherein the second light-emitting unit is adjacent to the infrared camera, and the first light-emitting unit is adjacent to the RGB camera.

12. The display device of claim 10, wherein the first sensor and the second sensor emit light in intersecting directions.

13. The display device of claim 9, wherein the first substrate and the second substrate are disposed in parallel to each other, and the first substrate and the second substrate are adjacent to each other in a first direction toward a side portion or a second direction perpendicular to the first direction.

14. The display device of claim 13, wherein the first sensor and the second sensor overlap at least partially in the first direction.

15. The display device of claim 13, further comprising:
a first light-transmitting member disposed between the sloped surface of the light guide plate and the display panel; and
a second reflector disposed on a sloped surface of the first light-transmitting member,
wherein the second reflector reflects light emitted from the second sensor to the display panel.

16. The display device of claim 15, further comprising a second light-transmitting member disposed on the sloped surface of the first light-transmitting member,
wherein the second reflector is disposed between the second light-transmitting member and the first light-transmitting member.

17. The display device of claim 1, wherein an opening area of a first pixel of the first display area has an area different from an opening area of a second pixel of the second display area.

18. The display device of claim 1, wherein a second pixel of the second display area includes a 2-1 pixel that outputs red, green, and blue light, and a 2-2 pixel that outputs white light.

19. The display device of claim 18, wherein an area of the 2-1 pixel is smaller than an area of the 2-2 pixel.

20. The display device of claim 1, further comprising an optical sheet disposed on the backlight unit,
wherein the optical sheet includes an opening corresponding to the second display area.
